(19) United States
(12) Patent Application Publication
(10) Pub. No.: US 2025/0361877 A1
(43) Pub. Date: Nov. 27, 2025

(54) DRYING-UP METHOD, COOLING-DOWN METHOD, AND HOT-UP METHOD FOR A PUMP APPARATUS

(71) Applicant: EBARA CORPORATION, Tokyo (JP)

(72) Inventors: Shuichiro HONDA, Tokyo (JP); Tetsuji KASATANI, Tokyo (JP); Hayato IKEDA, Tokyo (JP); Kei WATAJI, Tokyo (JP); Hyuga KIKUCHI, Tokyo (JP); Mitsutaka IWAMI, Tokyo (JP); Asaki SUZUKI, Tokyo (JP)

(21) Appl. No.: 18/867,871

(22) PCT Filed: May 25, 2023
(86) PCT No.: PCT/JP2023/019444

§ 371 Date: Nov. 21, 2024

(30) Foreign Application Priority Data
May 26, 2022 (JP) 2022-086314

(51) Int. Cl. F04D 29/58; F04D 7/02; F04D 13/08

(52) U.S. Cl. CPC F04D 29/588; F04D 7/02; F04D 13/086

(57) ABSTRACT

The drying-up method includes introducing a purge gas into a suction container of a pump apparatus, passing the purge gas through a flow-path switching device in the suction container while the purge gas bypasses a submersible pump in the suction container, introducing the purge gas that has passed through the flow-path switching device into a suction container of a pump apparatus, and passing the purge gas through the flow-path switching device in the suction container while the purge gas bypasses a submersible pump in the suction container.

### TECHNICAL FIELD

The present invention relates to a drying-up method, a cooling-down method, and a hot-up method for a submersible pump used for delivering liquefied gas, such as liquid hydrogen, liquid nitrogen, liquefied ammonia, liquefied natural gas, liquefied ethylene gas, or liquefied petroleum gas, and in particular to a technique for drying, cooling, and warming the submersible pump while preventing rotation of an impeller of the submersible pump when the submersible pump is not in operation.

### BACKGROUND ART

Natural gas is widely used for thermal power generation and used as a raw material for chemicals. Furthermore, hydrogen is expected to be an energy that does not generate carbon dioxide that causes global warming. Applications of hydrogen as an energy include fuel cell and turbine power generation. Natural gas and hydrogen are in a gaseous state at normal temperature, and therefore natural gas and hydrogen are cooled and liquefied for their storage and transportation. Liquefied gas, such as liquefied natural gas (LNG) or liquefied hydrogen, is temporarily stored in a liquefied-gas storage tank and then delivered to a power plant, factory, or the like by a pump.

FIG. 34 is a schematic diagram showing a conventional example of a pump apparatus for pumping up the liquefied gas. A pump 500 is installed in a vertical suction container 505 coupled to a liquefied-gas storage tank (not shown) in which the liquefied gas is stored. The liquefied gas is introduced into the suction container 505 through a suction port 501, and the suction container 505 is filled with the liquefied gas. The entire pump 500 is immersed in the liquefied gas. Therefore, the pump 500 is a submersible pump that can operate in the liquefied gas. When the pump 500 is in operation, the liquefied gas is discharged by the pump 500 through a discharge port 502. During the operation of the pump 500, a part of the liquefied gas in the suction container 505 is vaporized into gas, and this gas is discharged from the suction container 505 through a vent line 503.

Before the pump 500 is operated, a drying-up operation is performed in which air is removed from the suction container 505 by a purge gas, and a cooling-down operation is performed in which the pump 500 is cooled by the liquefied gas. If the air in the suction container 505 comes into contact with the ultra-low temperature liquefied gas, moisture in the air is cooled by the liquefied gas and solidified, which inhibits the rotational operation of the pump 500. Furthermore, if the pump 500 has a room temperature when the pump 500 is started, the liquefied gas will be vaporized when the ultra-low temperature liquefied gas comes into contact with the pump 500. In order to prevent such events, the drying-up operation and the cooling-down operation are performed before the operation of the pump 500 is started.

The drying-up operation is performed by injecting a purge gas (e.g., nitrogen gas) into the suction container 505, and the cooling-down operation is performed by injecting the liquefied gas (e.g., liquefied natural gas) into the suction container 505. The purge gas or liquefied gas that has been injected into the suction container 505 fills the suction container 505, flows into the pump 500 through a suction port 500a of the pump 500, and is discharged through the discharge port 502.

In addition, before the pump 500 having an ultra-low temperature is pulled out from the suction container 505 for maintenance or replacement of the pump 500, a hot-up operation is performed in which the pump 500 is warmed with a warming gas (for example, an inert gas at room temperature). This hot-up operation is performed before the pump 500 comes into contact with the surrounding air, so that components, such as nitrogen, in the air are not liquefied on a surface of the pump 500. In particular, the hot-up operation is effective when the liquefied gas is liquid hydrogen. Specifically, the pump 500 that has been immersed in liquid hydrogen has an ultra-low temperature equivalent to that of liquid hydrogen when the pump 500 is pulled out of the suction container 505. The boiling point of hydrogen (−253° C.) is lower than the boiling point of oxygen (−183° C.). Therefore, when the air comes into contact with the pump 500 immediately after the pump 500 is pulled out of the suction container 505, not only nitrogen but also oxygen in the air is liquefied and may drop into the suction container 505. In order to prevent this, the hot-up operation is performed so as to warm the pump 500 with the warming gas before the pump 500 is pulled out of the suction container 505. As a result, when the air comes into contact with the pump 500, the oxygen in the air is not liquefied, and thus the liquefied oxygen does not drop into the suction container 505.

### CITATION LIST

### Patent Literature

Patent document 1: Japanese laid-open utility model publication No. S59-159795

Patent document 2: Japanese examined utility model application publication No. S62-031680

### SUMMARY OF INVENTION

### Technical Problem

In order to pressurize the liquefied gas to target pressure required for a user, multiple pump apparatuses may be coupled in series as shown in FIG. 35. The liquefied gas is sequentially pressurized by pumps 500 of the multiple pump apparatuses.

However, when the above-mentioned drying-up operation is performed on the pump apparatuses coupled in series, the following problem may occur. Specifically, when the purge gas is delivered into the pump apparatuses before the start of their operations, the purge gas flows through all of the pumps 500. This flow of purge gas forcibly rotates impellers of the pumps 500 that are not in operation. As a result, sliding parts, such as bearings, may be damaged. In order to prevent such unintended rotation of the impellers of the pumps 500, it is possible to deliver the purge gas at a low flow rate. However, in this case, it takes a very long time for the drying-up operation to be completed in all of the pump apparatuses. Similar problems can occur during the cooling-down operation and the hot-up operation.

Therefore, the present invention provides a method for performing a drying-up operation, a cooling-down operation, and a hot-up operation on a submersible pump while preventing rotation of an impeller of the submersible pump when the submersible pump is not in operation.

### Solution to Problem

In an embodiment, there is provided a drying-up method for removing air from a plurality of pump apparatuses including at least a first pump apparatus and a second pump apparatus coupled in series, comprising: introducing a purge gas into a first suction container of the first pump apparatus; passing the purge gas through a first flow-path switching device in the first suction container while the purge gas bypasses a first submersible pump in the first suction container; introducing the purge gas that has passed through the first flow-path switching device into a second suction container of the second pump apparatus; and passing the purge gas through a second flow-path switching device in the second suction container while the purge gas bypasses a second submersible pump in the second suction container.

In an embodiment, each of the first flow-path switching device and the second flow-path switching device includes: a flow-passage structure having a pump-side flow passage, a container-side flow passage, and an outlet flow passage; and a valve element arranged in the flow-passage structure, the valve element being configured to allow the outlet flow passage to selectively communicate with either the pump-side flow passage or the container-side flow passage, the pump-side flow passage communicating with a discharge outlet of the corresponding submersible pump, the container-side flow passage communicating with an interior of the corresponding suction container, and the outlet flow passage communicating with a discharge port of the corresponding suction container.

In an embodiment, there is provided a drying-up method for removing air from a suction container that accommodates a submersible pump therein, comprising: forming a vacuum in the suction container; then introducing a purge gas into the suction container; and passing the purge gas through a flow-path switching device in the suction container while the purge gas bypasses the submersible pump.

In an embodiment, there is provided a cooling-down method for supplying liquefied gas to a plurality of pump apparatuses including at least a first pump apparatus and a second pump apparatus coupled in series, comprising: introducing a liquefied gas into a first suction container of the first pump apparatus; passing the liquefied gas through a first flow-path switching device in the first suction container while the liquefied gas bypasses a first submersible pump in the first suction container; introducing the liquefied gas that has passed through the first flow-path switching device into a second suction container of the second pump apparatus; and passing the liquefied gas through a second flow-path switching device in the second suction container while the liquefied gas bypasses a second submersible pump in the second suction container.

In an embodiment, each of the first flow-path switching device and the second flow-path switching device includes: a flow-passage structure having a pump-side flow passage, a container-side flow passage, and an outlet flow passage; and a valve element arranged in the flow-passage structure, the valve element being configured to allow the outlet flow passage to selectively communicate with either the pump-side flow passage or the container-side flow passage, the pump-side flow passage communicating with a discharge outlet of the corresponding submersible pump, the container-side flow passage communicating with an interior of the corresponding suction container, and the outlet flow passage communicating with a discharge port of the corresponding suction container.

In an embodiment, there is provided a cooling-down method for cooling a submersible pump disposed in a suction container, comprising introducing a liquefied gas into the suction container and passing the liquefied gas through a flow-path switching device in the suction container while the liquefied gas bypasses the submersible pump.

In an embodiment, here is provided a hot-up method for supplying warming gas to a plurality of pump apparatuses including at least a first pump apparatus and a second pump apparatus coupled in series, comprising: introducing a warming gas into a first suction container of the first pump apparatus; passing the warming gas through a first flow-path switching device in the first suction container while the warming gas bypasses a first submersible pump in the first suction container; introducing the warming gas that has passed through the first flow-path switching device into a second suction container of the second pump apparatus; and passing the warming gas through a second flow-path switching device in the second suction container while the warming gas bypasses a second submersible pump in the second suction container.

In an embodiment, each of the first flow-path switching device and the second flow-path switching device includes: a flow-passage structure having a pump-side flow passage, a container-side flow passage, and an outlet flow passage; and a valve element arranged in the flow-passage structure, the valve element being configured to allow the outlet flow passage to selectively communicate with either the pump-side flow passage or the container-side flow passage, the pump-side flow passage communicating with a discharge outlet of the corresponding submersible pump, the container-side flow passage communicating with an interior of the corresponding suction container, and the outlet flow passage communicating with a discharge port of the corresponding suction container.

In an embodiment, there is provided a hot-up method for warming a submersible pump disposed in a suction container, comprising: introducing a warming gas into the suction container and passing the warming gas through a flow-path switching device in the suction container while the warming gas bypasses the submersible pump.

### Advantageous Effects of Invention

The flow-path switching device can prevent gas (purge gas, warming gas) or liquefied gas that has been introduced into the suction container during the drying-up operation, the cooling-down operation, and the hot-up operation from being introduced into the submersible pump. Therefore, the impeller of the submersible pump does not rotate when the pump is not in operation, and as a result, damage to sliding parts of the submersible pump, such as bearings, can be prevented.

### BRIEF DESCRIPTION OF DRAWINGS

FIG. 1 is a diagram showing an embodiment of a pump apparatus for delivering liquefied gas;

FIG. 2 is a cross-sectional view showing an embodiment of detailed configuration of a flow-path switching device;

FIG. 3 shows a state of the flow-path switching device when a submersible pump is in operation;

FIG. 4 is a diagram for explaining an embodiment of a drying-up operation;

FIG. 5 is a diagram showing an embodiment of a process for forming a vacuum in a suction container;

FIG. 6 is a diagram showing an embodiment of a process for introducing a purge gas into a suction container;

FIG. 7 is a diagram for explaining an embodiment of a cooling-down operation;

FIG. 8 is a diagram for explaining another embodiment of a cooling-down operation;

FIG. 9 is a diagram for explaining an embodiment of a hot-up operation;

FIG. 10 is a diagram for explaining another embodiment of a hot-up operation for a submersible pump;

FIG. 11 is a schematic diagram showing an embodiment of a pump system having a plurality of pump apparatuses coupled in series;

FIG. 12 is a diagram explaining the drying-up operation for submersible pumps coupled in series shown in FIG. 11;

FIG. 13 is a diagram showing an embodiment of a process for forming a vacuum in a plurality of suction containers;

FIG. 14 is a diagram showing an embodiment of a process for introducing a purge gas into the plurality of suction containers;

FIG. 15 is a diagram showing an embodiment of a cooling-down operation for cooling the submersible pumps coupled in series shown in FIG. 11;

FIG. 16 is a diagram showing another embodiment of a cooling-down operation for cooling the submersible pumps coupled in series shown in FIG. 11;

FIG. 17 is a diagram showing an embodiment of a hot-up operation for warming the submersible pumps coupled in series shown in FIG. 11;

FIG. 18 is a diagram showing another embodiment of a hot-up operation for warming the submersible pumps coupled in series shown in FIG. 11;

FIG. 19 is a schematic diagram showing another embodiment of a pump system having a plurality of pump apparatuses coupled in series;

FIG. 20 is a diagram showing a drying-up operation for the plurality of pump apparatuses of the pump system shown in FIG. 19;

FIG. 21 is a diagram showing an embodiment of a process for forming a vacuum in a plurality of suction containers;

FIG. 22 is a diagram showing an embodiment of a process for introducing a purge gas into the plurality of suction containers;

FIG. 23 is a diagram explaining a cooling-down operation for submersible pumps coupled in series as shown in FIG. 19.

FIG. 24 is a diagram showing an embodiment of a cooling-down operation for the submersible pumps of the pump system shown in FIG. 19;

FIG. 25 is a diagram showing an embodiment of a hot-up operation for the plurality of pump apparatuses of the pump system shown in FIG. 19;

FIG. 26 is a diagram showing another embodiment of a hot-up operation for the plurality of pump apparatuses of the pump system shown in FIG. 19;

FIG. 27 is a schematic diagram showing yet another embodiment of a pump system having a plurality of pump apparatuses coupled in series;

FIG. 28 is a cross-sectional view showing another embodiment of a flow-path switching device;

FIG. 29 is a cross-sectional view showing yet another embodiment of a flow-path switching device;

FIG. 30 is a cross-sectional view showing another embodiment of a submersible pump;

FIG. 31 is a cross-sectional view showing yet another embodiment of a submersible pump;

FIG. 32 is a cross-sectional view showing an embodiment in which a gas vent valve is open.

FIG. 33 is a cross-sectional view showing an embodiment in which the gas vent valve is closed;

FIG. 34 is a schematic diagram showing a conventional example of a pump apparatus for pumping up liquefied gas; and

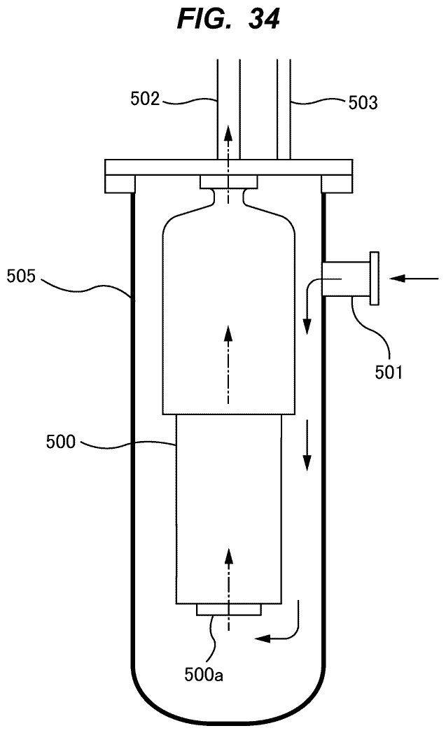

FIG. 35 is a schematic diagram showing an example of multiple pump apparatuses coupled in series.

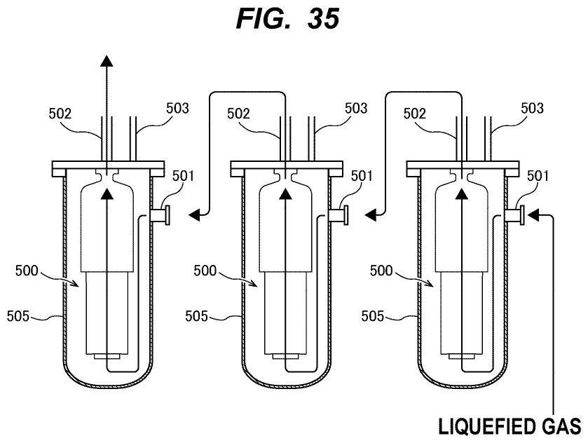

### DESCRIPTION OF EMBODIMENTS

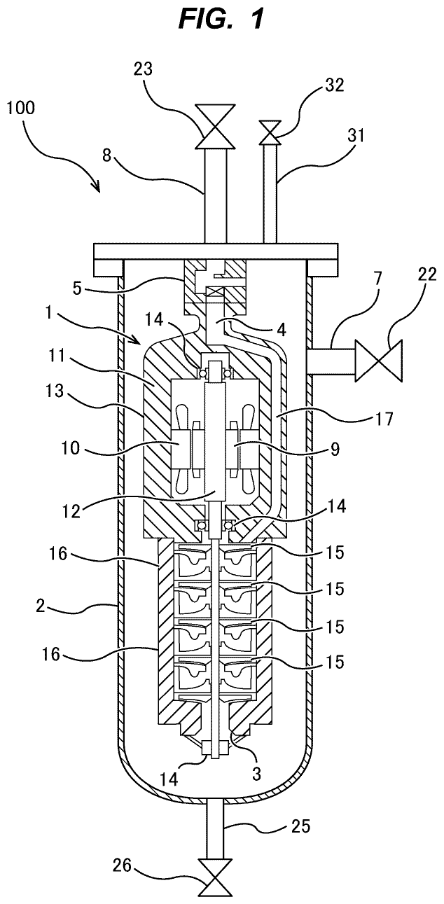

Hereinafter, embodiments of the present invention will be described with reference to the drawings. FIG. 1 is a diagram showing an embodiment of a pump apparatus for delivering liquefied gas. Examples of liquefied gas to be delivered by a pump apparatus 100 shown in FIG. 1 include liquid hydrogen, liquid nitrogen, liquefied ammonia, liquefied natural gas, liquefied ethylene gas, and liquefied petroleum gas.

As shown in FIG. 1, the pump apparatus 100 includes a submersible pump 1 for delivering the liquefied gas, a suction container 2 in which the submersible pump 1 is accommodated, and a flow-path switching device 5 for preventing rotation of impellers 15 of the submersible pump 1 when the submersible pump 1 is not in operation. The suction container 2 has a suction port 7 and a discharge port 8. The liquefied gas is introduced into the suction container 2 through the suction port 7, and the suction container 2 is filled with the liquefied gas. During operation of the submersible pump 1, the entire submersible pump 1 is immersed in the liquefied gas. Therefore, the submersible pump 1 is configured to be able to operate in the liquefied gas.

The submersible pump 1 includes an electric motor 11 having a motor rotor 9 and a motor stator 10, a rotation shaft 12 coupled to the electric motor 11, a plurality of bearings 14 that rotatably support the rotation shaft 12, impellers 15 fixed to the rotation shaft 12, and a pump casing 16 in which the impellers 15 are housed. The flow-path switching device 5 is disposed in the suction container 2. More specifically, the flow-path switching device 5 is coupled to both a discharge outlet 4 of the submersible pump 1 and the discharge port 8 of the suction container 2. Specific configurations of the flow-path switching device 5 will be described later.

The motor rotor 9 and the motor stator 10 are disposed in a motor housing 13. When electric power is supplied to the motor 11 through a power cable (not shown), the motor 11 rotates the rotation shaft 12 and the impellers 15 together. As the impellers 15 rotate, the liquefied gas is sucked into the submersible pump 1 through a suction inlet 3 and discharged into the flow-path switching device 5 through a discharge flow path 17 and the discharge outlet 4. The liquefied gas passes through the flow-path switching device 5 and is discharged through the discharge port 8 of the suction container 2.

A suction valve 22 is coupled to the suction port 7, and a discharge valve 23 is coupled to the discharge port 8. A drain line 25 is coupled to a bottom of the suction container 2, and a drain valve 26 is coupled to the drain line 25. The suction port 7 is provided on a side wall of the suction container 2 and is located higher than the bottom of the suction container 2. The discharge port 8 is provided on an upper portion of the suction container 2 and is located higher than the suction port 7. During operation of the submersible pump 1, the suction valve 22 and the discharge valve 23 are open, while the drain valve 26 is closed.

A vent line 31 is coupled to the upper portion of the suction container 2. During operation of the submersible pump 1, a part of the liquefied gas is vaporized into gas due to heat generation from the submersible pump 1, and this gas is discharged from the suction container 2 through the vent line 31. A vent valve 32 is coupled to the vent line 31. In one embodiment, this gas may be delivered to a gas treatment device (not shown) through the vent line 31. The gas treatment device is a device that treats gas (e.g., natural gas or hydrogen gas) vaporized from liquefied gas. Examples of the gas treatment device include a gas incinerator (flaring device), a chemical gas treatment device, and a gas adsorption device.

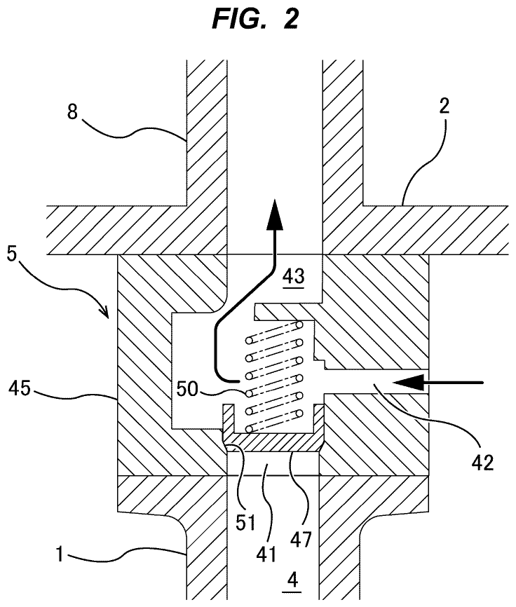

FIG. 2 is a cross-sectional view showing an embodiment of detailed configuration of the flow-path switching device 5. As shown in FIG. 2, the flow-path switching device 5 includes a flow-passage structure 45 and a valve element 47 arranged in the flow-passage structure 45. The flow-passage structure 45 has a pump-side flow passage 41, a container-side flow passage 42, and an outlet flow passage 43 therein. The pump-side flow passage 41 communicates with the discharge outlet 4 of the submersible pump 1, the container-side flow passage 42 communicates with an interior of the suction container 2, and the outlet flow passage 43 communicates with the discharge port 8 of the suction container 2. The valve element 47 is arranged to allow the outlet flow passage 43 to selectively communicate with either the pump-side flow passage 41 or the container-side flow passage 42. The configuration of the flow-path switching device 5 is not limited to the embodiment shown in FIG. 2 as long as the flow-path switching device 5 can perform its intended function.

FIG. 2 shows a state of the flow-path switching device 5 when the submersible pump 1 is not in operation. The valve element 47 is pressed against the flow-passage structure 45 by a spring 50 to thereby close the pump-side flow passage 41. More specifically, the flow-passage structure 45 has a valve seat 51 formed around an outlet of the pump-side flow passage 41. The valve element 47 is pressed against the valve seat 51 by the spring 50. Therefore, when the valve element 47 is pressed against the valve seat 51, the pump-side flow passage 41 is closed, while the container-side flow passage 42 and the outlet flow passage 43 are in fluid communication. The container-side flow passage 42 is open in the suction container 2 and communicates with the suction port 7 through the interior of the suction container 2.

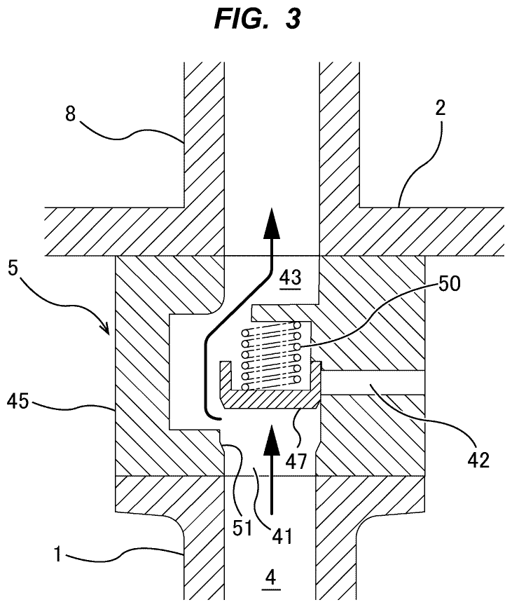

FIG. 3 shows a state of the flow-path switching device 5 when the submersible pump 1 is in operation. When the submersible pump 1 is in operation, the liquefied gas is discharged from the discharge outlet 4 of the submersible pump 1 and flows into the pump-side flow passage 41 of the flow-path switching device 5. The liquefied gas flowing through the pump-side flow passage 41 moves the valve element 47 against the force of the spring 50, thus opening the pump-side flow passage 41 and closing the container-side flow passage 42 with the valve element 47. As a result, the fluid communication between the pump-side flow passage 41 and the outlet flow passage 43 is established.

When the operation of the submersible pump 1 is stopped, the valve element 47 is pressed against the valve seat 51 by the spring 50. As a result, as shown in FIG. 2, the pump-side flow passage 41 is closed, while the container-side flow passage 42 and the outlet flow passage 43 communicate with each other. In this way, the flow-path switching device 5 of this embodiment operates only by the spring 50 and the flow of liquefied gas.

Before the operation of the submersible pump 1, a drying-up operation is performed in which is to remove air from the suction container 2 with purge gas, and a cooling-down operation is performed which is to cool the submersible pump 1 with the liquefied gas. The drying-up operation and cooling-down operation are performed when the operation of the submersible pump 1 is stopped. More specifically, the drying-up operation and cooling-down operation are performed when the pump-side flow passage 41 is closed by the valve element 47, and the container-side flow passage 42 and the outlet flow passage 43 are in fluid communication, as shown in FIG. 2.

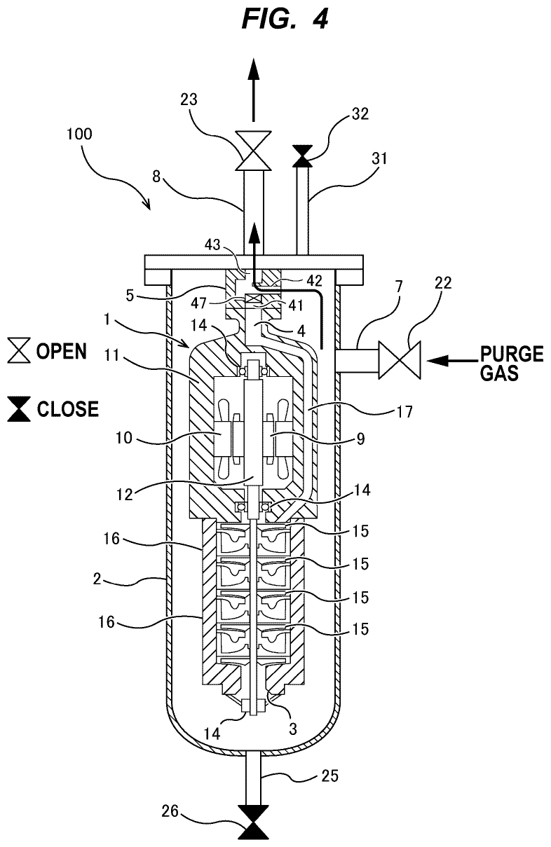

The drying up operation is an operation of introducing purge gas having a normal temperature into the suction container 2 to dry the submersible pump 1. An embodiment of the drying-up operation will be described below with reference to FIG. 4. When the submersible pump 1 is not in operation (i.e., the state shown in FIG. 2), the purge gas is delivered through the suction port 7 into the suction container 2. The drain valve 26 and the vent valve 32 are closed, and the suction valve 22 and the discharge valve 23 are open. The vent valve 32 may be open. The purge gas purges the air present in the suction container 2 and is discharged together with the air through the container-side flow passage 42 and the outlet flow passage 43 of the flow-path switching device 5, and the discharge port 8. The interior of the suction container 2 is filled with the purge gas, thereby drying the submersible pump 1.

In FIG. 4, the pump-side flow passage 41 is closed by the valve element 47. Therefore, the purge gas that has been introduced into the suction container 2 does not flow through the submersible pump 1. As a result, unintended rotation of the impellers 15 of the submersible pump 1 is prevented, and damage to sliding parts, such as the bearings 14, is prevented.

The purge gas used for the drying-up operation is an inert gas composed of element having a boiling point lower than that of an element constituting the liquefied gas. This is to prevent the purge gas from being liquefied when the purge gas comes into contact with the cryogenic liquefied gas introduced after the drying-up operation. For example, if the liquefied gas is liquefied natural gas (LNG), the purge gas used is nitrogen gas. In another example, if the liquefied gas is liquid hydrogen, the purge gas used is helium gas.

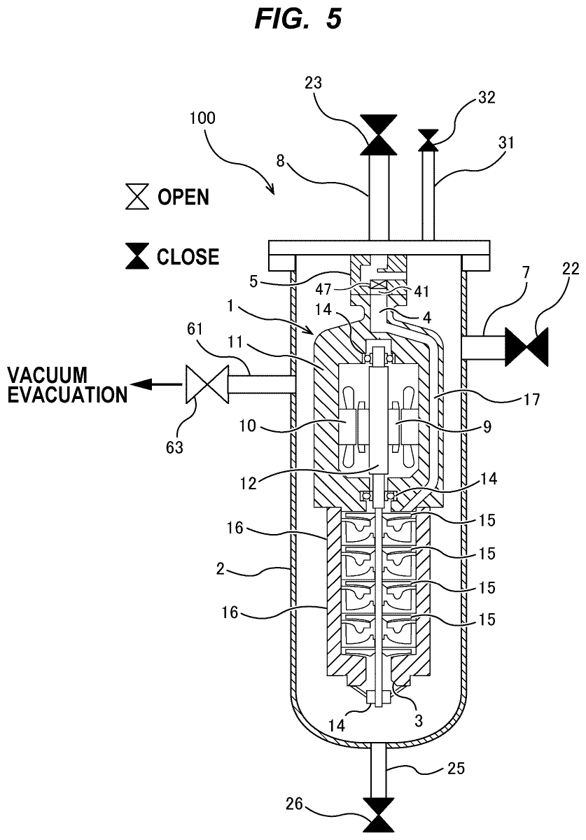

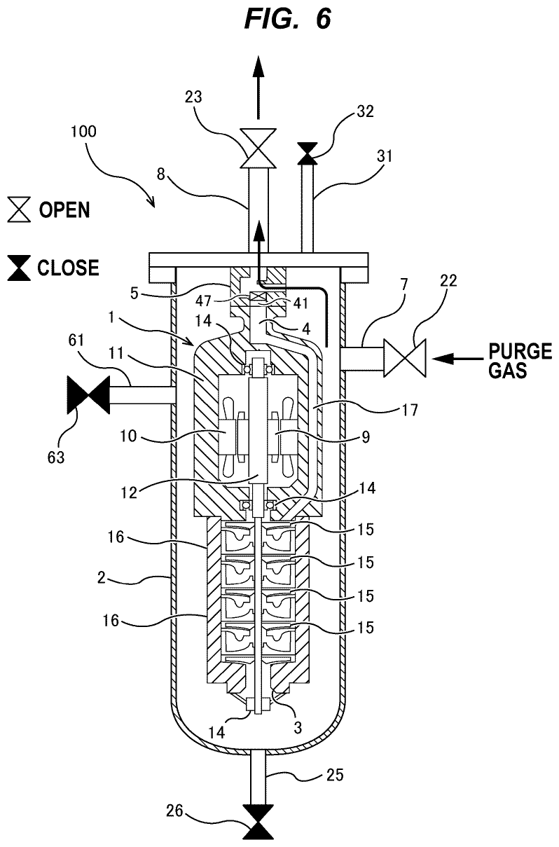

FIGS. 5 and 6 are diagrams for explaining another embodiment of the drying-up operation. Configuration and operation of this embodiment that will not be specifically described are the same as those of the embodiments described above with reference to FIG. 4, and therefore a duplicated description will be omitted.

In the embodiment shown in FIGS. 5 and 6, the pump apparatus 100 includes a vacuum port 61 coupled to the suction container 2 and a vacuum valve 63 coupled to the vacuum port 61. The vacuum port 61 is coupled to the interior of the suction container 2 and is coupled to a vacuum source (e.g., a vacuum pump) which is not shown. In this embodiment, the drying-up operation includes forming a vacuum in the suction container 2 and introducing the purge gas into the suction container 2. The processes of forming a vacuum in the suction container 2 and introducing the purge gas into the suction container 2 may be repeated multiple times until an amount of air in the suction container 2 is reduced to an acceptable level.

FIG. 5 shows one embodiment of forming a vacuum in the suction container 2. The suction valve 22, the discharge valve 23, the drain valve 26, and the vent valve 32 are closed. When the vacuum valve 63 is opened, a vacuum is formed in the suction container 2. FIG. 6 shows one embodiment of introducing the purge gas into the suction container 2. When the vacuum has been formed in the suction container 2, the vacuum valve 63 is closed and the suction valve 22 is opened. The purge gas is supplied into the suction container 2 through the suction port 7. Thereafter, when the pressure in the suction container 2 becomes equal to or higher than the atmospheric pressure, the discharge valve 23 is opened.

During the drying-up operation, the submersible pump 1 is not in operation. Therefore, the flow-path switching device 5 is in the state shown in FIG. 2. The purge gas bypasses the submersible pump 1 (i.e., the purge gas does not flow inside the submersible pump 1) and passes through the flow-path switching device 5.

By repeating the process of creating a vacuum in the suction container 2 shown in FIG. 5 and the process of introducing the purge gas into the suction container 2 shown in FIG. 6 several times, the amount of air in the suction container 2 can be reduced to an acceptable level. In the embodiment shown in FIG. 5 and FIG. 6, the vacuum port 61 is coupled to the side wall of the suction container 2, but the position of the vacuum port 61 is not limited to this embodiment. In one embodiment, the vacuum port 61 may be coupled to a top wall of the suction container 2.

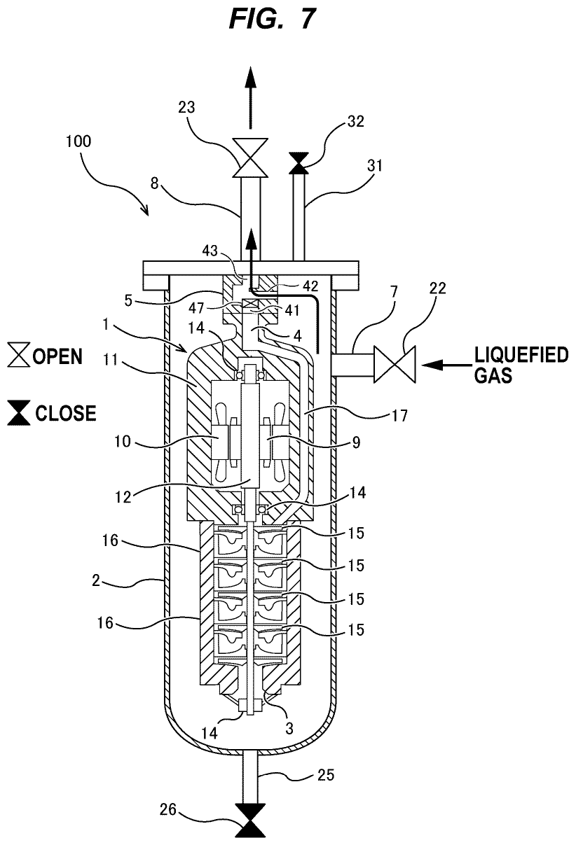

The cooling-down operation for the submersible pump 1 is performed after the drying-up operation is completed and before the submersible pump 1 is started. FIG. 7 is a diagram for explaining one embodiment of the cooling-down operation for the submersible pump 1. When the submersible pump 1 is not in operation (i.e., the state shown in FIG. 2), the liquefied gas is supplied through the suction port 7 into the suction container 2. The drain valve 26 and the vent valve 32 are closed, and the suction valve 22 and the discharge valve 23 are opened. The vent valve 32 may be open. The liquefied gas comes into contact with the submersible pump 1 in the suction container 2 and is discharged through the container-side flow passage 42 and the outlet flow passage 43 of the flow-path switching device 5, and the discharge port 8. The interior of the suction container 2 is filled with the liquefied gas, which cools the submersible pump 1.

During the cooling-down operation, the submersible pump 1 is not in operation. In FIG. 7, the pump-side flow passage 41 is closed by the valve element 47. Therefore, the liquefied gas that has been introduced into the suction container 2 does not flow through the submersible pump 1. In other words, the liquefied gas bypasses the submersible pump 1 and passes through the flow-path switching device 5. As a result, unintended rotation of the impellers 15 of the submersible pump 1 is prevented, and damage to sliding parts, such as the bearings 14, is prevented.

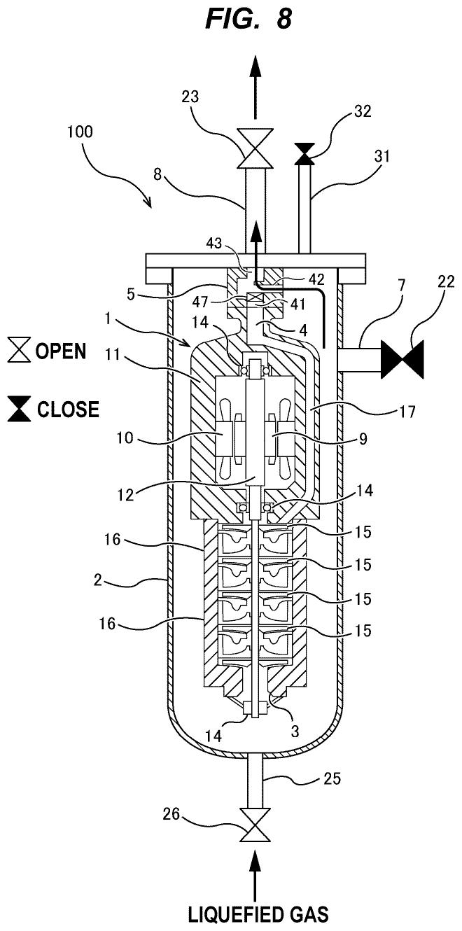

FIG. 8 is a diagram for explaining another embodiment of the cooling-down operation for the submersible pump 1. When the submersible pump 1 is not in operation (i.e., the state shown in FIG. 2), the liquefied gas is supplied into the suction container 2 through the drain line 25 coupled to the bottom of the suction container 2. The suction valve 22 and the vent valve 32 are closed, and the drain valve 26 and the discharge valve 23 are open. The vent valve 32 may be open. While the liquefied gas is introduced from the bottom of the suction container 2, a liquid level of the liquefied gas in the suction container 2 gradually rises. The liquefied gas (and gas evaporated from the liquefied gas) comes into contact with the submersible pump 1 in the suction container 2 and is discharged through the container-side flow passage 42 and the outlet flow passage 43 of the flow-path switching device 5 and the discharge port 8. The interior of the suction container 2 is filled with the liquefied gas, which cools the submersible pump 1.

During the cooling-down operation, the submersible pump 1 is not in operation. In FIG. 8, the pump-side flow passage 41 is closed by the valve element 47. Therefore, the liquefied gas that has been introduced into the suction container 2 does not flow through the submersible pump 1. In other words, the liquefied gas bypasses the submersible pump 1 and passes through the flow-path switching device 5. As a result, unintended rotation of the impellers 15 of the submersible pump 1 is prevented, and damage to sliding parts, such as the bearings 14, is prevented.

before the submersible pump 1 having an ultra-low temperature is pulled out from the suction container 2 for maintenance or replacement of the submersible pump 1, a hot-up operation is performed in which the submersible pump 1 is warmed with a warming gas. This hot-up operation is performed before the submersible pump 1 comes into contact with the surrounding air, so that components, such as nitrogen, in the air are not liquefied on a surface of the submersible pump 1. In particular, the hot-up operation is effective when the liquefied gas is liquid hydrogen. Specifically, the submersible pump 1 that has been immersed in liquid hydrogen has an ultra-low temperature equivalent to that of liquid hydrogen when the submersible pump 1 is pulled out of the suction container 2. The boiling point of hydrogen (−253° C.) is lower than the boiling point of oxygen (−183° C.). Therefore, when the air comes into contact with the submersible pump 1 immediately after the submersible pump 1 is pulled out of the suction container 2, not only nitrogen but also oxygen in the air is liquefied and may drop into the suction container 2. In order to prevent this, the hot-up operation is performed so as to warm the submersible pump 1 with the warming gas before the submersible pump 1 is pulled out of the suction container 2. As a result, when the air comes into contact with the submersible pump 1, the oxygen in the air is not liquefied, and thus the liquefied oxygen does not drop into the suction container 2.

An example of the warming gas is an inert gas having an ordinary or room temperature composed of element having a boiling point equal to or lower than a boiling point of element constituting the liquefied gas. This is to prevent the warming gas from being liquefied when the warming gas comes into contact with the cryogenic submersible pump 1. For example, when the liquefied gas is liquefied natural gas (LNG), the warming gas is nitrogen gas. In another example, when the liquefied gas is liquid hydrogen, the warming gas is helium gas. In one embodiment, the warming gas may be vaporized liquefied gas (also called boil-off gas (BOG)). For example, a boil-off gas in a liquefied-gas storage tank (not shown) that stores the liquefied gas, which is arranged upstream of the submersible pump 1, may be used as the warming gas.

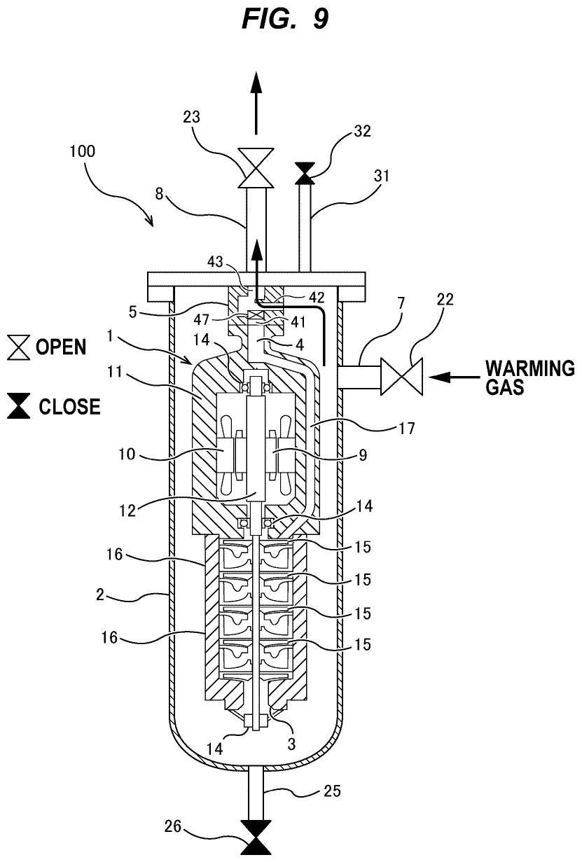

FIG. 9 is a diagram for explaining an embodiment of the hot-up operation performed on the submersible pump 1. As shown in FIG. 9, when the submersible pump 1 is not in operation (i.e., the state shown in FIG. 2), the warming gas is supplied into the suction container 2 through the suction port 7. The drain valve 26 and the vent valve 32 are closed, and the suction valve 22 and the discharge valve 23 are open. The vent valve 32 may be open. The warming gas bypasses the submersible pump 1 (i.e., the warming gas does not flow inside the submersible pump 1) and passes through the flow-path switching device 5. The warming gas comes into contact with the submersible pump 1 in the suction container 2 and is discharged through the container-side flow passage 42 and the outlet flow passage 43 of the flow-path switching device 5, and the discharge port 8. The interior of the suction container 2 is filled with the warming gas, which warms the submersible pump 1.

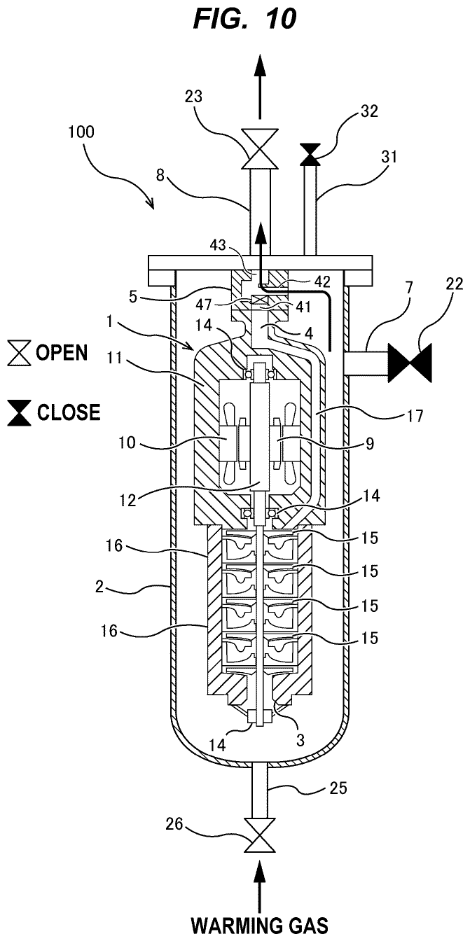

FIG. 10 is a diagram for explaining another embodiment of the hot-up operation for the submersible pump 1. When the submersible pump 1 is not in operation (i.e., the state shown in FIG. 2), the warming gas is supplied into the suction container 2 through the drain line 25 coupled to the bottom of the suction container 2. The suction valve 22 and the vent valve 32 are closed, and the drain valve 26 and the discharge valve 23 are open. The vent valve 32 may be open. The warming gas is introduced from the bottom of the suction container 2, contacts the submersible pump 1 in the suction container 2, and is discharged through the vessel-side flow passage 42 and the outlet flow passage 43 of the flow-path switching device 5, and the discharge port 8. The interior of the suction container 2 is filled with the warming gas, which warms the submersible pump 1.

During the hot-up operation, the submersible pump 1 is not in operation. In FIG. 10, the pump-side flow passage 41 is closed by the valve element 47. Therefore, the warming gas that has been introduced into the suction container 2 does not flow through the submersible pump 1. In other words, the warming gas bypasses the submersible pump 1 and passes through the flow-path switching device 5. As a result, unintended rotation of the impellers 15 of the submersible pump 1 is prevented, and damage to sliding parts, such as the bearings 14, is prevented.

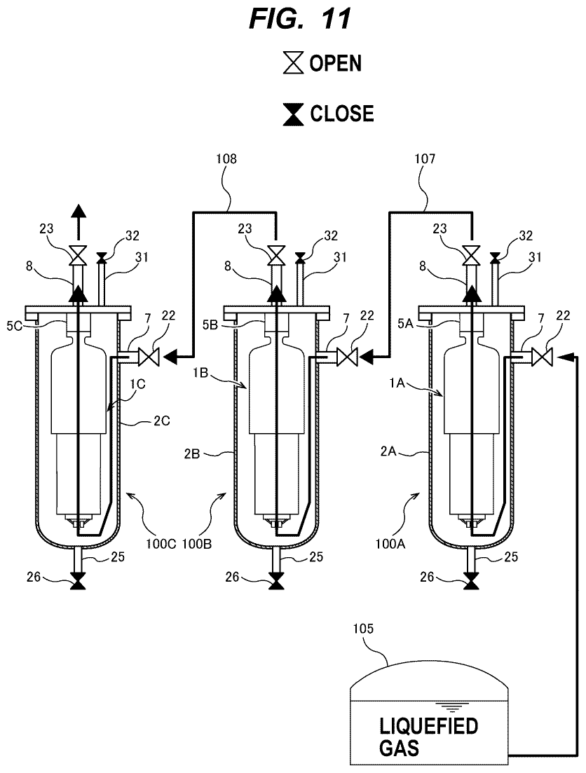

In order to pressurize the liquefied gas to a target pressure required by a user, a plurality of pump apparatuses 100 may be coupled in series. FIG. 11 is a schematic diagram showing an embodiment of a pump system including a plurality of pump apparatuses 100A, 100B, and 100C coupled in series. In FIG. 11, the plurality of pump apparatuses 100A, 100B, and 100C have the same configuration as the pump apparatus 100 described with reference to FIGS. 1 to 10. In the following description, submersible pump, suction container, and flow-path switching device of the pump apparatus 100A are referred to as submersible pump 1A, suction container 2A, and flow-path switching device 5A, respectively. Submersible pump, suction container, and flow-path switching device of the pump apparatus 100B are referred to as submersible pump 1B, suction container 2B, and flow-path switching device 5B, respectively. Submersible pump, suction container, and flow-path switching device of the pump apparatus 100C are referred to as submersible pump 1C, suction container 2C, and flow-path switching device 5C, respectively.

The pump apparatus 100A is disposed upstream of the pump apparatus 100B, which is disposed upstream of the pump apparatus 100C. The suction port 7 of the pump apparatus 100A is coupled to a liquefied-gas storage tank 105 in which the liquefied gas is stored. The pump apparatus 100A is coupled in series to the pump apparatus 100B by a communication line 107, and the pump apparatus 100B is coupled in series to the pump apparatus 100C by a communication line 108. More specifically, the discharge port 8 of the pump apparatus 100A is coupled to the suction port 7 of the pump apparatus 100B by the communication line 107, and the discharge port 8 of the pump apparatus 100B is coupled to the suction port 7 of the pump apparatus 100C by the communication line 108.

The submersible pumps 1A, 1B, and 1C are coupled in series in the order of the submersible pump 1A, the submersible pump 1B, and the submersible pump 1C. The liquefied gas is successively pressurized by these submersible pumps 1A, 1B, and 1C. When the submersible pumps 1A, 1B, and 1C are in operation and transferring the liquefied gas, the flow-path switching devices 5A, 5B, and 5C are in the state shown in FIG. 3.

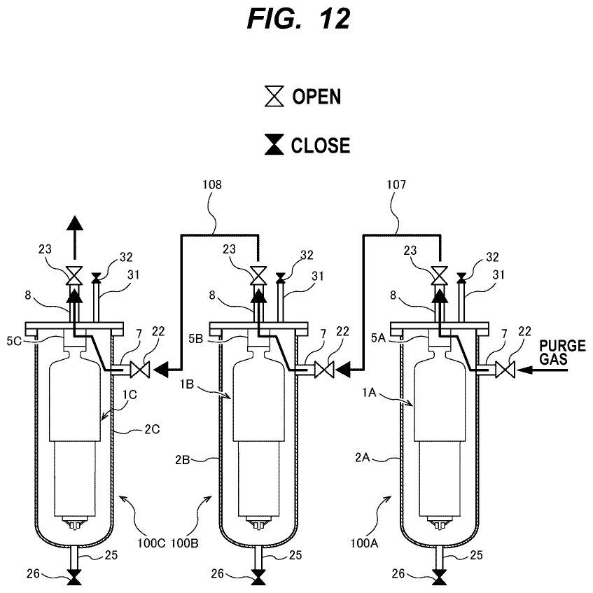

FIG. 12 is a diagram for explaining an embodiment of the drying-up operation for the submersible pumps 1A, 1B, and 1C coupled in series as shown in FIG. 11. As shown in FIG. 12, the purge gas flows into the suction containers 2A, 2B, and 2C of the pump apparatuses 100A, 100B, and 100C sequentially through the suction ports 7 of the suction containers 2A, 2B, and 2C. During the drying-up operation, the submersible pumps 1A, 1B, and 1C are not in operation. Therefore, the flow-path switching devices 5A, 5B, and 5C are in the state shown in FIG. 2. Therefore, the purge gas bypasses the submersible pumps 1A, 1B, and 1C (i.e., the purge gas does not flow through the submersible pumps 1A, 1B, and 1C) and passes through the flow-path switching devices 5A, 5B, and 5C.

More specifically, the purge gas is first introduced into the suction container 2A of the pump apparatus 100A through the suction port 7. The purge gas passes through the flow-path switching device 5A while bypassing the submersible pump 1A. The purge gas that has passed through the flow-path switching device 5A is introduced into the suction container 2B through the communication line 107 and the suction port 7 of the pump apparatus 100B. The purge gas passes through the flow-path switching device 5B while bypassing the submersible pump 1B. Furthermore, the purge gas that has passed through the flow-path switching device 5B is introduced into the suction container 2C through the communication line 108 and the suction port 7 of the pump apparatus 100C. The purge gas passes through the flow-path switching device 5C while bypassing the submersible pump 1C. The purge gas is discharged through the discharge port 8 of the pump apparatus 100C.

In this way, the flow-path switching devices 5A, 5B, 5C can prevent the purge gas that has been introduced into the suction containers 2A, 2B, 2C during the drying-up operation from being introduced into the submersible pumps 1A, 1B, 1C. Therefore, the impellers of the submersible pumps 1A, 1B, 1C that are not in operation do not rotate. As a result, damage to sliding parts, such as the bearings of the submersible pumps 1A, 1B, 1C, can be prevented.

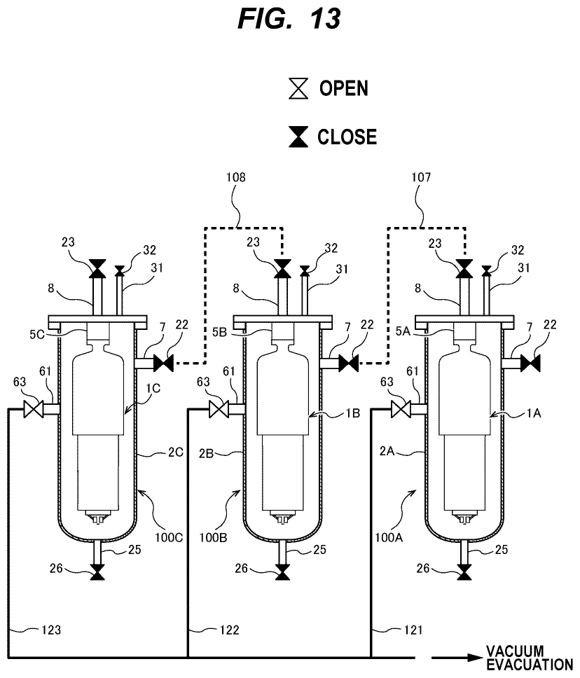

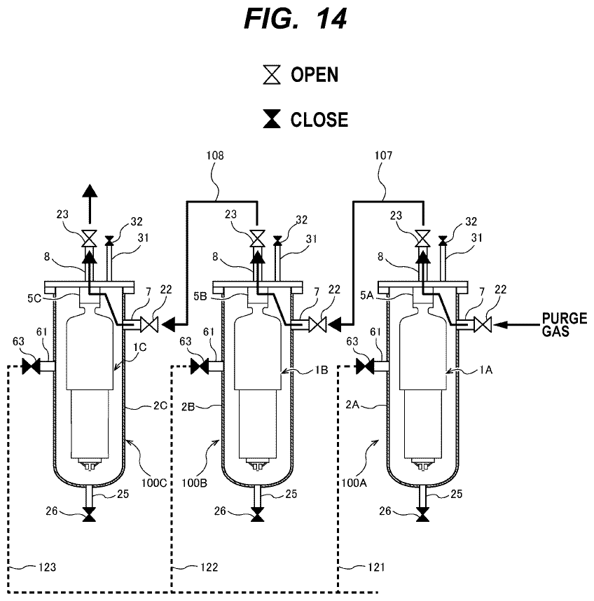

FIGS. 13 and 14 are diagrams for explaining an embodiment of the drying-up operation performed for the plurality of pump apparatuses 100A, 100B, and 100C according to the embodiments described with reference to FIGS. 5 and 6. Configuration and operation of this embodiment that will not be specifically described are the same as those of the embodiments described with reference to FIG. 12, and therefore redundant description will be omitted. Vacuum ports 61 and vacuum valves 63 of the pump apparatuses 100A, 100B, and 100C are coupled to vacuum lines 121, 122, and 123, respectively.

FIG. 13 illustrates one embodiment of a process for creating a vacuum in the suction containers 2A, 2B, and 2C of the pumping apparatuses 100A, 100B, and 100C. As shown in FIG. 13, the suction valves 22, the discharge valves 23, the drain valves 26, and the vent valves 32 of the pumping apparatuses 100A, 100B, and 100C are closed, while the vacuum valves 63 of the pumping apparatuses 100A, 100B, and 100C are opened. As a result, the vacuum is created in the suction containers 2A, 2B, and 2C.

FIG. 14 shows an embodiment of a process for introducing the purge gas into the suction containers 2A, 2B, 2C. When the vacuum has been formed in the suction containers 2A, 2B, 2C, the vacuum valves 63 of the pump apparatuses 100A, 100B, 100C are closed and the suction valves 22 of the pump apparatuses 100A, 100B, 100C are opened. The purge gas flows into the suction containers 2A, 2B, 2C of the pump apparatuses 100A, 100B, 100C sequentially through the respective suction ports 7. Then, when the pressure in the suction containers 2A, 2B, 2C becomes equal to or higher than the atmospheric pressure, the discharge valves 23 of the pump apparatuses 100A, 100B, 100C are opened. During the drying-up operation, the submersible pumps 1A, 1B, 1C are not in operation. Therefore, the flow-path switching devices 5A, 5B, 5C are in the state shown in FIG. 2. The purge gas bypasses the submersible pumps 1A, 1B, and 1C (i.e., the purge gas does not flow through the insides of the submersible pumps 1A, 1B, and 1C) and passes through the flow-path switching devices 5A, 5B, and 5C.

The process of forming the vacuum in the suction containers 2A, 2B, 2C shown in FIG. 13 and the process of introducing the purge gas into the suction containers 2A, 2B, 2C shown in FIG. 14 may be repeated multiple times until an amount of air in the suction containers 2A, 2B, 2C is reduced to an acceptable level.

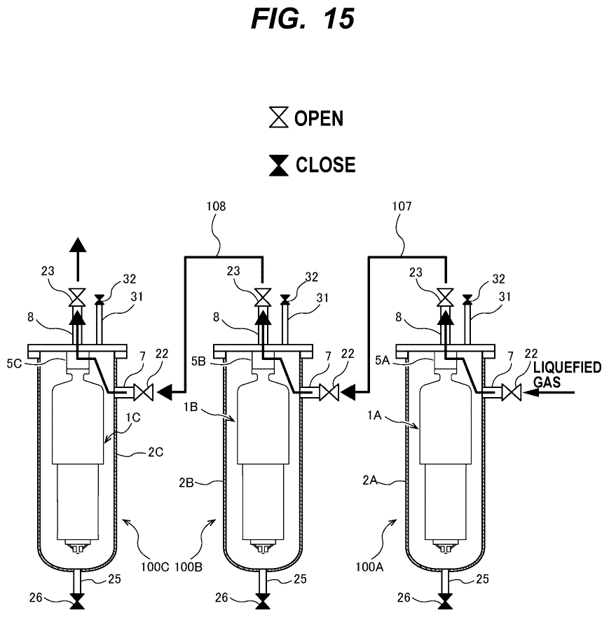

FIG. 15 is a diagram showing an embodiment of the cooling-down operation for cooling the submersible pumps 1A, 1B, and 1C. As shown in FIG. 15, the liquefied gas flows into the suction containers 2A, 2B, and 2C of the pump apparatuses 100A, 100B, and 100C sequentially through the suction ports 7 of the suction containers 2A, 2B, and 2C. During the cooling-down operation, the submersible pumps 1A, 1B, and 1C are not in operation. Therefore, the flow-path switching devices 5A, 5B, and 5C are in the state shown in FIG. 2. Therefore, the liquefied gas bypasses the submersible pumps 1A, 1B, and 1C (i.e., the liquefied gas does not flow inside the submersible pumps 1A, 1B, and 1C) and passes through the flow-path switching devices 5A, 5B, and 5C.

More specifically, the liquefied gas is first introduced into the suction container 2A of the pump apparatus 100A through the suction port 7. The liquefied gas passes through the flow-path switching device 5A while bypassing the submersible pump 1A. The liquefied gas that has passed through the flow-path switching device 5A is introduced into the suction container 2B through the communication line 107 and the suction port 7 of the pump apparatus 100B. The liquefied gas passes through the flow-path switching device 5B while bypassing the submersible pump 1B. Furthermore, the liquefied gas that has passed through the flow-path switching device 5B is introduced into the suction container 2C through the communication line 108 and the suction port 7 of the pump apparatus 100C. The liquefied gas passes through the flow-path switching device 5C while bypassing the submersible pump 1C. The liquefied gas is discharged through the discharge port 8 of the pump apparatus 100C.

In this way, the flow-path switching devices 5A, 5B, 5C can prevent the liquefied gas that has been introduced into the suction containers 2A, 2B, 2C during the cooling-down operation from being introduced into the submersible pumps 1A, 1B, 1C. Therefore, the impellers of the submersible pumps 1A, 1B, 1C that are not in operation do not rotate. As a result, damage to the sliding parts, such as the bearings of the submersible pumps 1A, 1B, 1C, can be prevented.

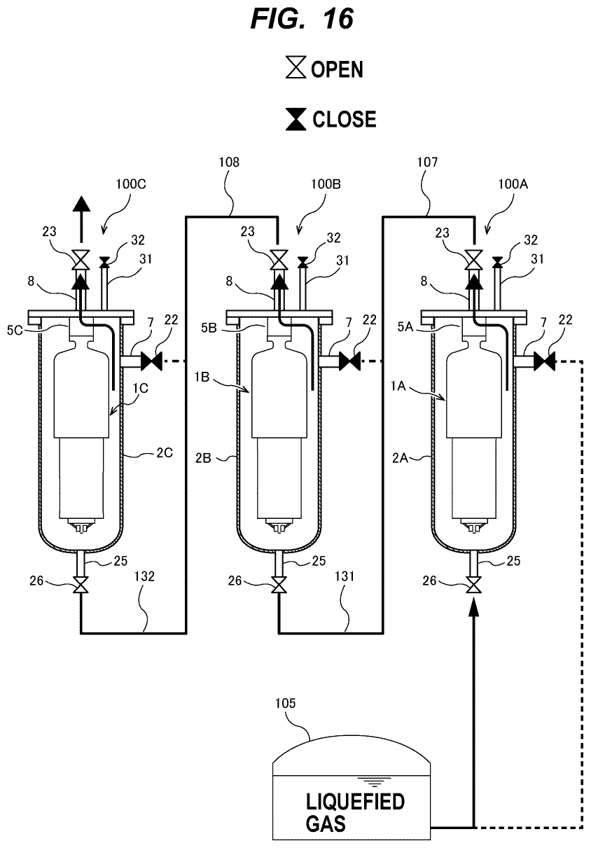

FIG. 16 is a diagram showing another embodiment of the cooling-down operation for cooling the submersible pumps 1A, 1B, and 1C. As shown in FIG. 16, the drain line 25 and the drain valve 26 of the pump apparatus 100A are coupled to the liquefied-gas storage tank 105 in which the liquefied gas is stored.

The drain line 25 and the drain valve 26 of the pump apparatus 100B are coupled to the discharge port 8 of the pump apparatus 100A through a communication line 131. A portion of the communication line 107 that couples the suction port 7 of the pump apparatus 100B to the discharge port 8 of the pump apparatus 100A may constitute a portion of the communication line 131. The drain line 25 and the drain valve 26 of the pump apparatus 100C are coupled to the discharge port 8 of the pump apparatus 100B through a communication line 132. A portion of the communication line 108 that couples the suction port 7 of the pump apparatus 100C to the discharge port 8 of the pump apparatus 100B may constitute a portion of the communication line 132.

In the cooling-down operation, the liquefied gas is sequentially supplied into the suction containers 2A, 2B, 2C through the drain lines 25 coupled to the bottoms of the suction containers 2A, 2B, 2C. The suction valves 22 and the vent valves 32 are closed, while the drain valves 26 and the discharge valves 23 are open. As the liquefied gas is introduced from the bottoms of the suction containers 2A, 2B, 2C, the liquid levels of the liquefied gas in the suction containers 2A, 2B, 2C gradually rise.

During the cooling-down operation, the submersible pumps 1A, 1B, and 1C are not in operation, and the flow-path switching devices 5A, 5B, and 5C are in the state shown in FIG. 2. Therefore, the liquefied gas bypasses the submersible pumps 1A, 1B, and 1C (i.e., the liquefied gas does not flow through the submersible pumps 1A, 1B, and 1C) and passes through the flow-path switching devices 5A, 5B, and 5C.

More specifically, the liquefied gas is first introduced into the suction container 2A of the pump apparatus 100A through the drain line 25. The liquefied gas passes through the flow-path switching device 5A while bypassing the submersible pump 1A. The liquefied gas that has passed through the flow-path switching device 5A is introduced into the suction container 2B through the communication line 131 and the drain line 25 of the pump apparatus 100B. The liquefied gas passes through the flow-path switching device 5B while bypassing the submersible pump 1B. Furthermore, the liquefied gas that has passed through the flow-path switching device 5B is introduced into the suction container 2C through the communication line 132 and the drain line 25 of the pump apparatus 100C. The liquefied gas passes through the flow-path switching device 5C while bypassing the submersible pump 1C. The liquefied gas is discharged through the discharge port 8 of the pump apparatus 100C.

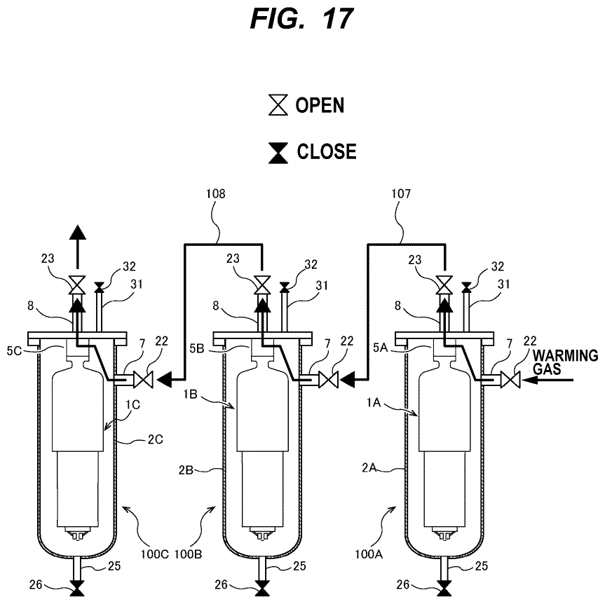

FIG. 17 is a diagram showing an embodiment of the hot-up operation for warming the submersible pumps 1A, 1B, and 1C. As shown in FIG. 17, the warming gas flows into the suction containers 2A, 2B, and 2C of the pump apparatuses 100A, 100B, and 100C sequentially through the suction ports 7. During the hot-up operation, the submersible pumps 1A, 1B, and 1C are not in operation. Therefore, the flow-path switching devices 5A, 5B, and 5C are in the state shown in FIG. 2. Therefore, the warming gas bypasses the submersible pumps 1A, 1B, and 1C (i.e., the warming gas does not flow through the submersible pumps 1A, 1B, and 1C) and passes through the flow-path switching devices 5A, 5B, and 5C.

More specifically, the warming gas is first introduced into the suction container 2A of the pump apparatus 100A through the suction port 7. The warming gas passes through the flow-path switching device 5A while bypassing the submersible pump 1A. The warming gas that has passed through the flow-path switching device 5A is introduced into the suction container 2B through the communication line 107 and the suction port 7 of the pump apparatus 100B. The warming gas passes through the flow-path switching device 5B while bypassing the submersible pump 1B. Furthermore, the warming gas that has passed through the flow-path switching device 5B is introduced into the suction container 2C through the communication line 108 and the suction port 7 of the pump apparatus 100C. The warming gas passes through the flow-path switching device 5C while bypassing the submersible pump 1C. The warming gas is discharged through the discharge port 8 of the pump apparatus 100C.

In this way, the flow-path switching devices 5A, 5B, 5C can prevent the warming gas that has been introduced into the suction containers 2A, 2B, 2C during the hot-up operation from being introduced into the submersible pumps 1A, 1B, 1C. Therefore, the impellers of the submersible pumps 1A, 1B, 1C that are not in operation do not rotate. As a result, damage to the sliding parts, such as the bearings of the submersible pumps 1A, 1B, 1C, can be prevented.

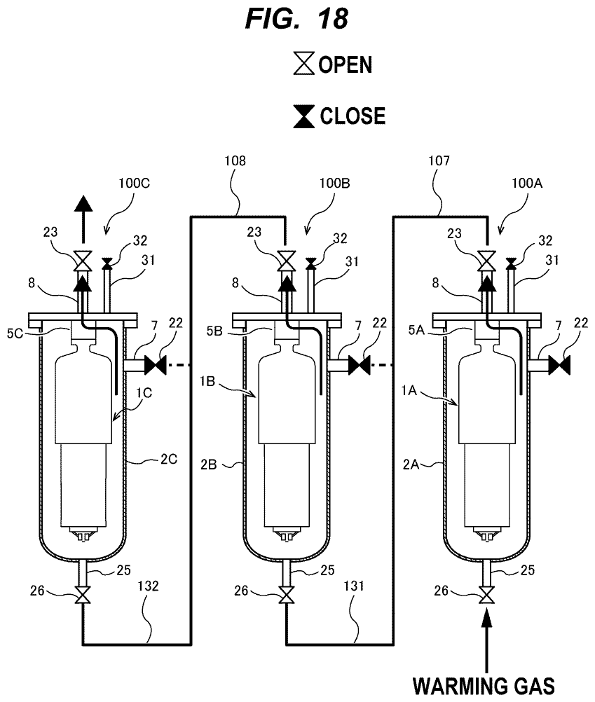

FIG. 18 is a diagram showing another embodiment of the hot-up operation for warming the submersible pumps 1A, 1B, and 1C. The drain line 25 and the drain valve 26 of the pump apparatus 100B are coupled to the discharge port 8 of the pump apparatus 100A through a communication line 131. A portion of the communication line 107 that couples the suction port 7 of the pump apparatus 100B to the discharge port 8 of the pump apparatus 100A may constitute a portion of the communication line 131. The drain line 25 and the drain valve 26 of the pump apparatus 100C are coupled to the discharge port 8 of the pump apparatus 100B through a communication line 132. A portion of the communication line 108 that couples the suction port 7 of the pump apparatus 100C to the discharge port 8 of the pump apparatus 100B may constitute a portion of the communication line 132.

In the hot-up operation, the warming gas is sequentially delivered into the suction containers 2A, 2B, 2C through the drain lines 25 coupled to the bottoms of the suction containers 2A, 2B, 2C. The suction valves 22 and the vent valves 32 are closed, while the drain valves 26 and the discharge valves 23 are open. The warming gas is introduced from the bottoms of the suction containers 2A, 2B, 2C and comes into contact with the submersible pumps 1A, 1B, 1C in the suction containers 2A, 2B, 2C.

During the hot-up operation, the submersible pumps 1A, 1B, and 1C are not in operation, and the flow-path switching devices 5A, 5B, and 5C are in the state shown in FIG. 2. Therefore, the warming gas bypasses the submersible pumps 1A, 1B, and 1C (i.e., the warming gas does not flow through the submersible pumps 1A, 1B, and 1C) and passes through the flow-path switching devices 5A, 5B, and 5C.

More specifically, the warming gas is first introduced into the suction container 2A of the pump apparatus 100A through the drain line 25. The warming gas passes through the flow-path switching device 5A while bypassing the submersible pump 1A. The warming gas that has passed through the flow-path switching device 5A is introduced into the suction container 2B through the communication line 131 and the drain line 25 of the pump apparatus 100B. The warming gas passes through the flow-path switching device 5B while bypassing the submersible pump 1B. Furthermore, the warming gas that has passed through the flow-path switching device 5B is introduced into the suction container 2C through the communication line 132 and the drain line 25 of the pump apparatus 100C. The warming gas passes through the flow-path switching device 5C while bypassing the submersible pump 1C. The warming gas is discharged through the discharge port 8 of the pump apparatus 100C.

The embodiments of the pump system shown in FIGS. 11 to 18 include three pump apparatuses 100A, 100B, and 100C coupled in series, while the number of pump apparatuses is not limited to these embodiments. In one embodiment, the pump system may include only two pump apparatuses coupled in series, or may include four or more pump apparatuses coupled in series.

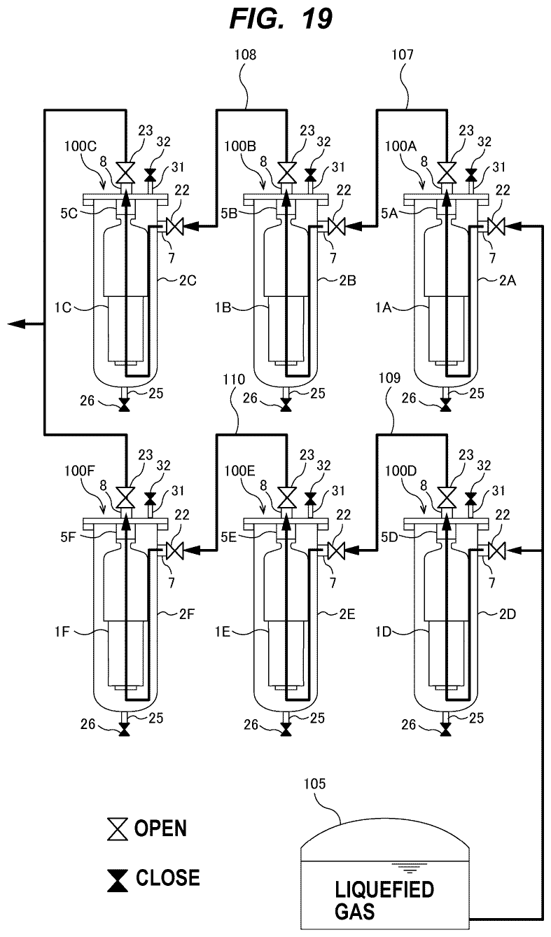

FIG. 19 is a schematic diagram showing another embodiment of a pump system including a plurality of pump apparatuses coupled in series. Configuration and operation of this embodiment that will not be specifically described are the same as those of the embodiment described with reference to FIG. 11, and therefore duplicated description will be omitted. The pump system of the embodiment shown in FIG. 19 further includes pump apparatuses 100D, 100E, and 100F coupled in series in addition to the pump apparatuses 100A, 100B, and 100C coupled in series.

The pump apparatus 100D includes a suction container 2D, a submersible pump 1D disposed in the suction container 2D, and a flow-path switching device 5D disposed in the suction container 2D. The pump apparatus 100E includes a suction container 2E, a submersible pump 1E disposed in the suction container 2E, and a flow-path switching device 5E disposed in the suction container 2E. The pump apparatus 100F includes a suction container 2F, a submersible pump 1F disposed in the suction container 2F, and a flow-path switching device 5F disposed in the suction container 2F.

The pump apparatus 100D is coupled in series to the pump apparatus 100E by a communication line 109, and the pump apparatus 100E is coupled in series to the pump apparatus 100F by a communication line 110. More specifically, the discharge port 23 of the pump apparatus 100D is coupled to the suction port 7 of the pump apparatus 100E by the communication line 109. The discharge port 23 of the pump apparatus 100E is coupled to the suction port 7 of the pump apparatus 100F by the communication line 110.

The pump apparatuses 100D, 100E, and 100F are arranged in parallel with the pump apparatuses 100A, 100B, and 100C. The pump apparatuses 100A, 100B, 100C, 100D, 100E, and 100F have the same configuration as the pump apparatus 100 described with reference to FIGS. 1 to 3, and therefore duplicated descriptions thereof will be omitted. The pump apparatuses 100A and 100D are coupled to the liquefied-gas storage tank 105 in which the liquefied gas is stored. According to the embodiment shown in FIG. 19, the liquefied gas is pumped by the submersible pumps 1A to 1C of the pump apparatuses 100A to 100C and by the submersible pumps 1D to 1F of the pump apparatuses 100D to 100F arranged in parallel.

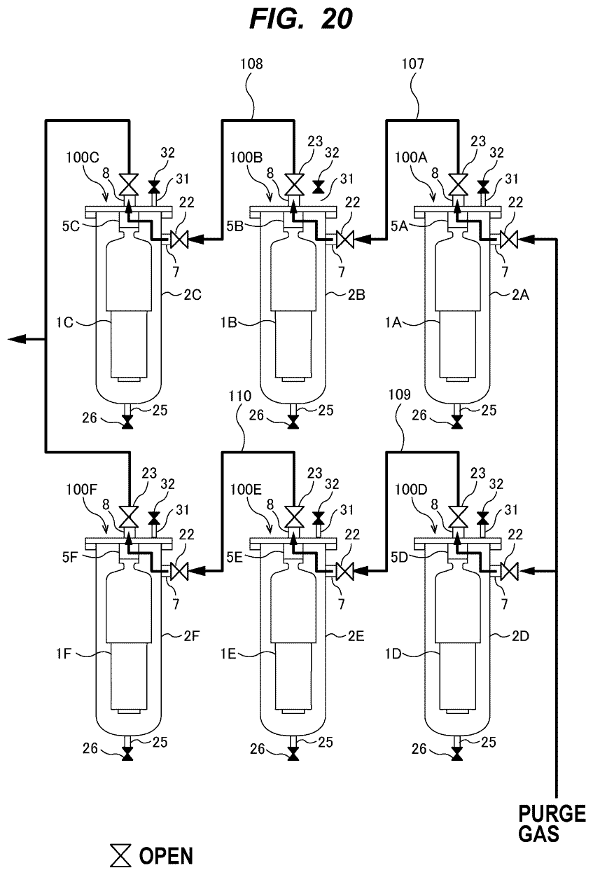

FIG. 20 is a diagram showing an embodiment of the drying-up operation performed on the plurality of pump apparatuses 100A to 100F of the pump system shown in FIG. 19. As shown in FIG. 20, the suction valves 22 and the discharge valves 23 of the pump apparatuses 100A to 100F are opened, and the drain valves 26 and the vent valves 32 are closed. The purge gas flows in parallel through the pump apparatuses 100A to 100C and the pump apparatuses 100D to 100F. More specifically, the purge gas is introduced into the suction containers 2A, 2B, 2C, 2D, 2E, and 2F through the respective suction ports 7. Furthermore, the purge gas flows through the flow-path switching devices 5A to 5F while bypassing the submersible pumps 1A to 1F (without flowing through the insides of the submersible pumps 1A to 1F) as described with reference to FIG. 4.

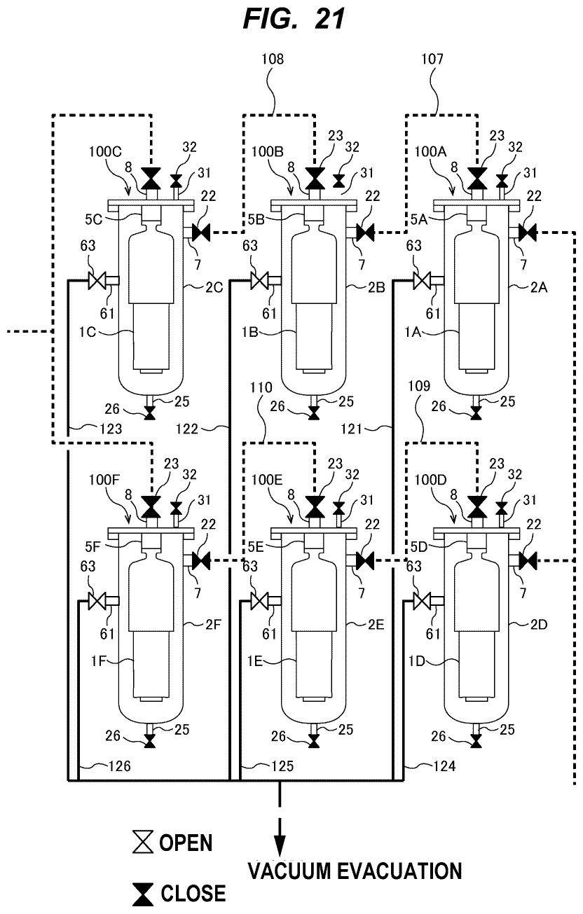

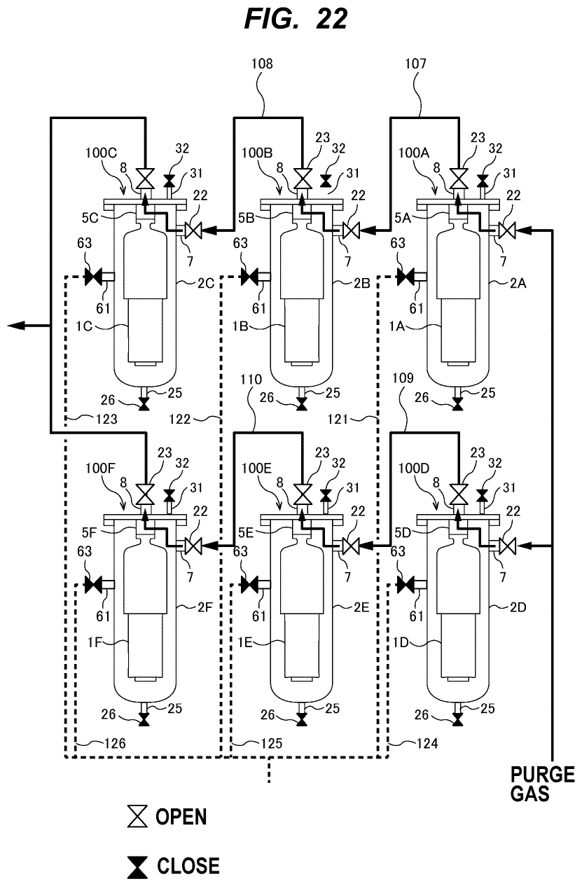

FIGS. 21 and 22 are diagrams showing an embodiment the drying-up operation performed on the plurality of pump apparatuses 100A to 100F according to the embodiment described with reference to FIGS. 5 and 6. Arrangement of the pump apparatuses 100A to 100F that will not be specifically described is the same as that in the embodiment described with reference to FIG. 19, and therefore a duplicated description will be omitted.

The vacuum ports 61 and the vacuum valves 63 of the pumping apparatuses 100A, 100B, and 100C are coupled to vacuum lines 121, 122, and 123, respectively, and the vacuum ports 61 and the vacuum valves 63 of the pumping apparatuses 100D, 100E, and 100F are coupled to vacuum lines 124, 125, and 126, respectively. The vacuum lines 121, 122, 123, 124, 125, and 126 are coupled to a vacuum source (e.g., a vacuum pump) not shown.

FIG. 21 illustrates one embodiment of a process for creating a vacuum in the suction containers 2A to 2F of the pumping apparatus 100A to 100F. As shown in FIG. 21, the suction valves 22, the discharge valves 23, the drain valves 26, and the vent valves 32 of the pumping apparatus 100A to 100F are closed, while the vacuum valves 63 of the pumping apparatus 100A to 100F are opened. As a result, the vacuum is created in the suction containers 2A to 2F.

FIG. 22 shows an embodiment of a process for introducing the purge gas into the suction containers 2A to 2F. When the vacuum has been formed in the suction containers 2A to 2F, the vacuum valves 63 of the pump apparatuses 100A to 100F are closed and the suction valves 22 are opened. The purge gas flows into the suction containers 2A to 2F of the pump apparatuses 100A to 100F sequentially through the suction ports 7 of the pump apparatuses 100A to 100F. Then, when the pressure in the suction containers 2A to 2F becomes equal to or higher than the atmospheric pressure, the discharge valves 23 of the pump apparatuses 100A to 100F are opened. During the drying-up operation, the submersible pumps 1A to 1F are not in operation. Therefore, the flow-path switching devices 5A to 5F are in the state shown in FIG. 2. The purge gas bypasses the submersible pumps 1A to 1F (i.e., the purge gas does not flow through the insides of the submersible pumps 1A to 1F) and passes through the flow-path switching devices 5A to 5F.

The process of forming the vacuum in the suction containers 2A to 2F shown in FIG. 21 and the process of introducing the purge gas into the suction containers 2A to 2F shown in FIG. 22 may be repeated multiple times until an amount of air in the suction containers 2A to 2F is reduced to an acceptable level.

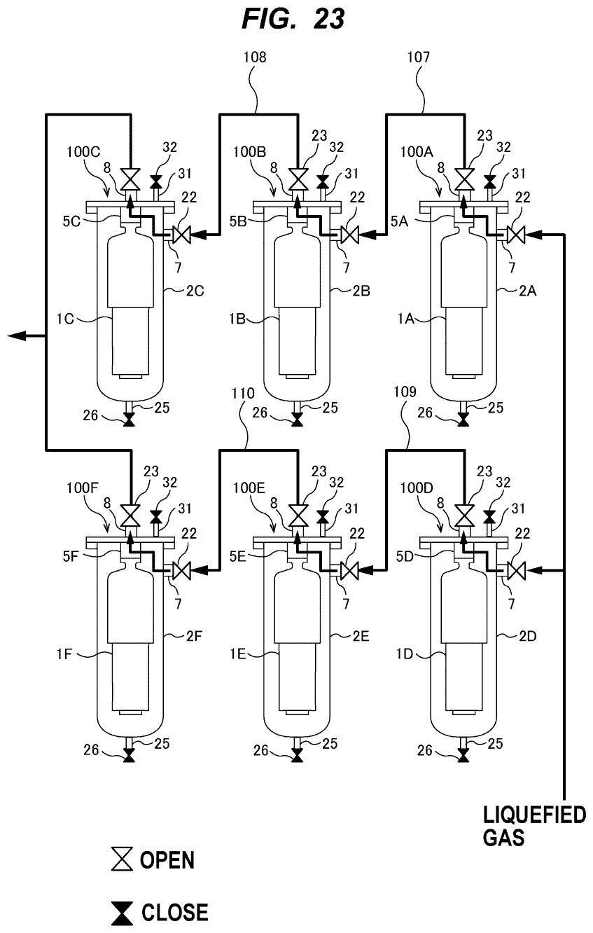

FIG. 23 is a diagram showing an embodiment of performing the cooling-down operation on the plurality of pump apparatuses 100A to 100F of the pump system shown in FIG. 19. As shown in FIG. 23, the suction valves 22 and the discharge valves 23 of the pump apparatuses 100A to 100F are opened, and the drain valves 26 and the vent valves 32 of the pump apparatuses 100A to 100F are closed. The liquefied gas flows in parallel through the pump apparatuses 100A to 100C and the pump apparatuses 100D to 100F. More specifically, the liquefied gas is introduced into the suction containers 2A, 2B, 2C, 2D, 2E, and 2F through the respective suction ports 7. Furthermore, the liquefied gas flows through the flow-path switching devices 5A to 5F while bypassing the submersible pumps 1A to 1F (without flowing through the insides of the submersible pumps 1A to 1F) as described with reference to FIG. 7.

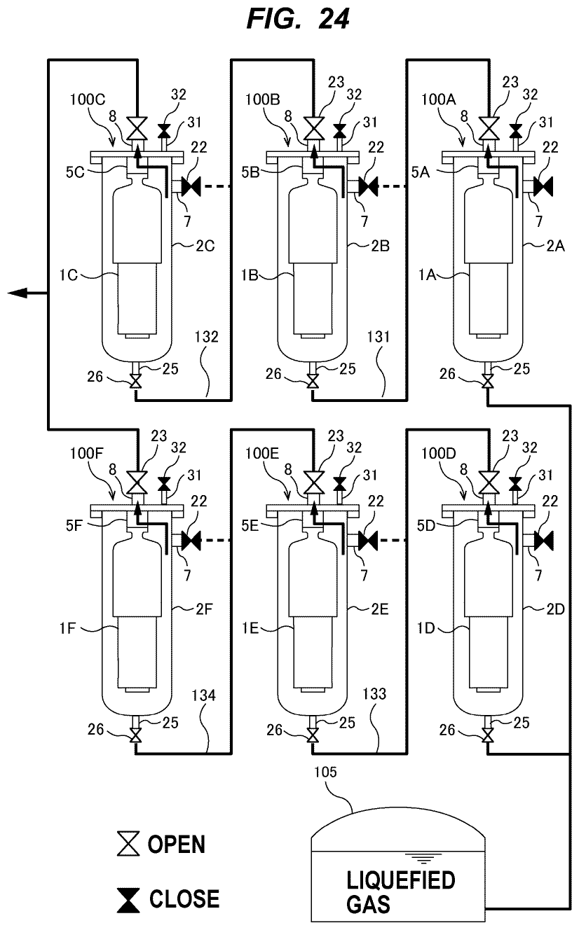

FIG. 24 is a diagram showing another embodiment of performing the cooling-down operation on the multiple pump apparatuses 100A to 100F of the pump system shown in FIG. 19. As shown in FIG. 24, the drain lines 25 and the drain valves 26 of the pump apparatuses 100A and 100D are coupled to the liquefied-gas storage tank 105 in which the liquefied gas is stored.

The drain line 25 and the drain valve 26 of the pump apparatus 100B are coupled to the discharge port 8 of the pump apparatus 100A through the communication line 131. The drain line 25 and the drain valve 26 of the pump apparatus 100C are coupled to the discharge port 8 of the pump apparatus 100B through the communication line 132. The drain line 25 and the drain valve 26 of the pump apparatus 100E are coupled to the discharge port 8 of the pump apparatus 100D through a communication line 133. The drain line 25 and the drain valve 26 of the pump apparatus 100F are coupled to the discharge port 8 of the pump apparatus 100E through a communication line 134.

During the cooling-down operation, the suction valves 22 and the vent valves 32 of the pump apparatuses 100A to 100F are closed, while the drain valves 26 and the discharge valves 23 of the pump apparatuses 100A to 100F are open. The liquefied gas flows in parallel through the pump apparatuses 100A to 100C and the pump apparatuses 100D to 100F. More specifically, the liquefied gas is introduced into the suction containers 2A, 2B, 2C, 2D, 2E, and 2F through their respective drain lines 25. As the liquefied gas is introduced from the bottoms of the suction containers 2A to 2F, the liquid levels of the liquefied gas in the suction containers 2A to 2F gradually rise.

During the cooling-down operation, the submersible pumps 1A to 1F are not in operation. Therefore, the flow-path switching devices 5A to 5F are in the state shown in FIG. 2. As described with reference to FIG. 8, the liquefied gas flows through the flow-path switching devices 5A to 5F while bypassing the submersible pumps 1A to 1F (without flowing through the insides of the submersible pumps 1A to 1F).

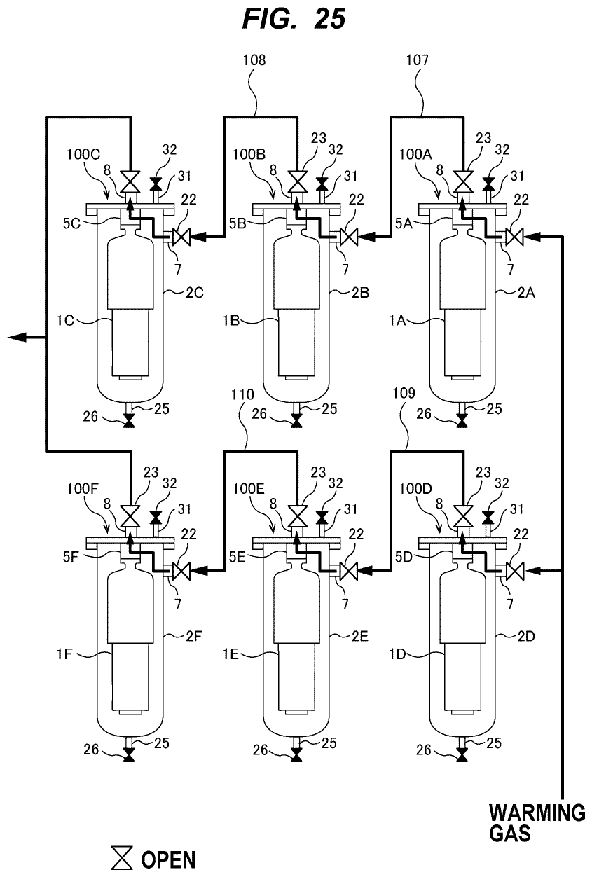

FIG. 25 is a diagram showing an embodiment of the hot-up operation performed for the plurality of pump apparatuses 100A to 100F of the pump system shown in FIG. 19. As shown in FIG. 25, the suction valves 22 and the discharge valves 23 of the pump apparatuses 100A to 100F are opened, and the drain valves 26 and the vent valves 32 of the pump apparatuses 100A to 100F are closed. The warming gas flows in parallel through the pump apparatuses 100A to 100C and the pump apparatuses 100D to 100F. More specifically, the warming gas is introduced into the suction containers 2A, 2B, 2C, 2D, 2E, and 2F through the respective suction ports 7. Furthermore, the warming gas flows through the flow-path switching devices 5A to 5F while bypassing the submersible pumps 1A to 1F (without flowing through the insides of the submersible pumps 1A to 1F) as described with reference to FIG. 9.

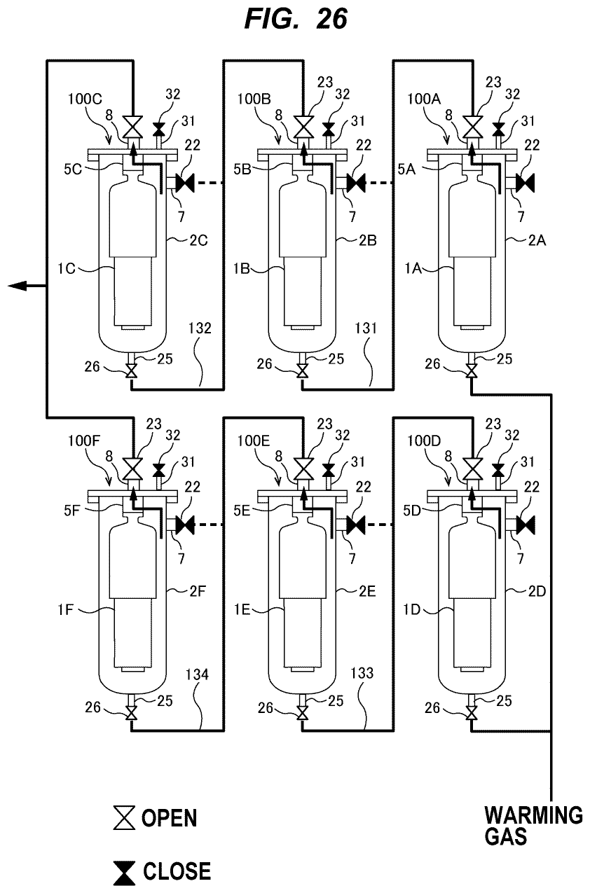

FIG. 26 is a diagram showing another embodiment of the hot-up operation performed on the plurality of pump apparatuses 100A to 100F of the pump system shown in FIG. 19. As shown in FIG. 26, the drain line 25 and the drain valve 26 of the pump apparatus 100B are coupled to the discharge port 8 of the pump apparatus 100A through the communication line 131. The drain line 25 and the drain valve 26 of the pump apparatus 100C are coupled to the discharge port 8 of the pump apparatus 100B through the communication line 132. The drain line 25 and the drain valve 26 of the pump apparatus 100E are coupled to the discharge port 8 of the pump apparatus 100D through the communication line 133. The drain line 25 and the drain valve 26 of the pump apparatus 100F are coupled to the discharge port 8 of the pump apparatus 100E through the communication line 134.

In the hot-up operation, the suction valves 22 and the vent valves 32 of the pump apparatuses 100A to 100F are closed, while the drain valves 26 and the discharge valves 23 of the pump apparatuses 100A to 100F are open. The warming gas flows in parallel through the pump apparatuses 100A to 100C and the pump apparatuses 100D to 100F. More specifically, the warming gas is introduced into the suction containers 2A, 2B, 2C, 2D, 2E, and 2F through their respective drain lines 25. The warming gas contacts the submersible pumps 1A to 1F in the suction containers 2A to 2F while being introduced from the bottom of the suction containers 2A to 2F.

During the hot-up operation, the submersible pumps 1A to 1F are not in operation. Therefore, the flow-path switching devices 5A to 5F are in the state shown in FIG. 2. As described with reference to FIG. 10, the warming gas flows through the flow-path switching devices 5A to 5F while bypassing the submersible pumps 1A to 1F (without flowing through the insides of the submersible pumps 1A to 1F).

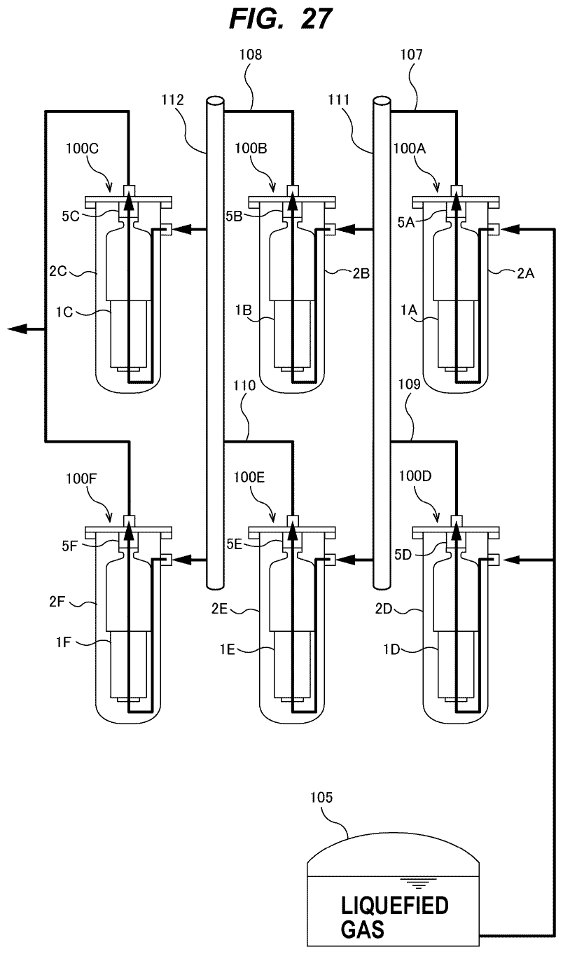

FIG. 27 is a schematic diagram showing yet another embodiment of a pump system including a plurality of pump apparatuses coupled in series. Configuration and operation of this embodiment that will not be specifically described are the same as those of the embodiment described with reference to FIG. 19, and therefore repetitive description will be omitted. In the embodiment shown in FIG. 27, the communication line 107 coupling the pump apparatus 100A to the pump apparatus 100B is coupled to the communication line 109 coupling the pump apparatus 100D to the pump apparatus 100E by an intermediate header 111. In addition, the communication line 108 coupling the pump apparatus 100B to the pump apparatus 100C is coupled to the communication line 110 coupling the pump apparatus 100E to the pump apparatus 100F by an intermediate header 112.

The pump apparatuses 100A to 100C are also coupled in series to the pump apparatuses 100D to 100F by the intermediate headers 111, 112. As a result, various flows of the liquefied gas are formed, allowing various operations of the pump apparatuses 100A to 100C and the pump apparatuses 100D to 100F. For example, it is possible to stop the operation of the pump apparatus 100C or the pump apparatus 100F for maintenance or depending on the pressure required by a user.

The drying-up operation, the cooling-down operation, and the hot-up operation for the pump system shown in FIG. 27 are performed in the same manner as the embodiments described with reference to FIGS. 20 to 26. The purge gas, the liquefied gas, and the warming gas can flow through the intermediate headers 111, 112 in various ways.

In the pump systems shown in FIGS. 19 and 27, two rows of pump apparatuses 100A to 100C and pump apparatuses 100D to 100F are provided in parallel, while three or more rows of pump apparatuses may be provided in parallel.

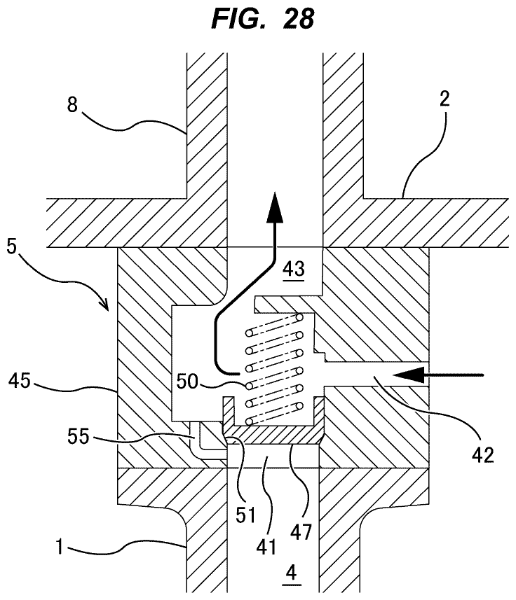

FIG. 28 is a cross-sectional view showing another embodiment of the flow-path switching device 5. Configuration and operation of this embodiment that will not be specifically described are the same as those of the embodiment described with reference to FIG. 2 and FIG. 3, and repetitive description will be omitted. As shown in FIG. 28, the flow-passage structure 45 includes a bypass flow passage 55 that communicates the pump-side flow passage 41 and the outlet flow passage 43. The bypass flow passage 55 has a cross-sectional area smaller than a cross-sectional area of the pump-side flow passage 41. More specifically, the cross-sectional area of the bypass flow passage 55 is such that the impellers 15 of the submersible pump 1 do not rotate due to the flow of the fluid (the purge gas, the liquefied gas, or the warming gas) when the valve element 47 closes the pump-side flow passage 41 and when the fluid flows through the submersible pump 1 and the bypass flow passage 55.

The bypass flow passage 55 may be a through-hole as shown in FIG. 28 or a groove formed in the valve seat 51. A plurality of bypass flow passages 55 may be provided as long as the fluid does not rotate the impellers 15. According to this embodiment, the fluid (e.g., the purge gas, the liquefied gas, or the warming gas) can be smoothly introduced into the inside of the submersible pump 1 during the drying-up operation, the cooling-down operation, and the hot-up operation. As a result, the drying-up operation, the cooling-down operation, and the hot-up operation for the submersible pump 1 can be completed in a shorter time. In particular, the bypass flow passage 55 can eliminate a liquid level difference between the inside and outside of the submersible pump 1 when the liquefied gas is introduced into the suction container 2 during the cooling-down operation, and can reduce a stress generated in the submersible pump 1 due to a temperature difference between the inside and outside of the submersible pump 1.

The flow-path switching device 5 described with reference to FIG. 28 may be applied to the flow-path switching devices 5, 5A to 5F in the embodiments described with reference to FIGS. 4 to 27.

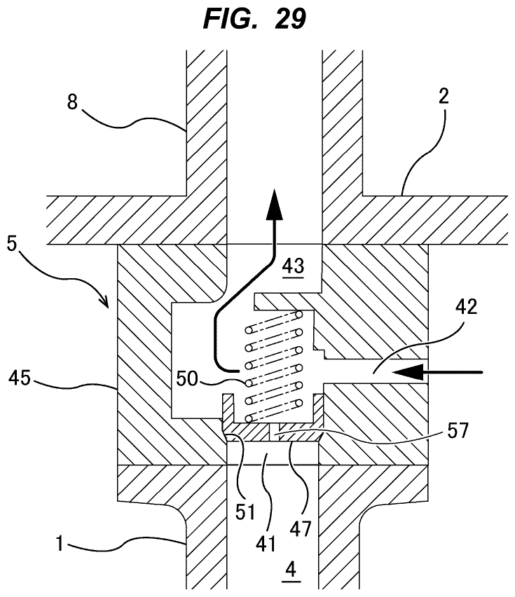

FIG. 29 is a cross-sectional view showing yet another embodiment of the flow-path switching device 5. Configuration and operation of this embodiment that will not be particularly described are the same as those of the embodiment described with reference to FIG. 2 and FIG. 3, and repetitive description will be omitted. As shown in FIG. 29, the valve element 47 has a through-hole 57 that provides a fluid communication between the pump-side flow passage 41 and the outlet flow passage 43. The through-hole 57 extends from a pump side to an opposite side of the valve element 47. A cross-sectional area of the through-hole 57 is smaller than the cross-sectional area of the pump-side flow passage 41. More specifically, the cross-sectional area of the through-hole 57 is such that the impellers 15 of the submersible pump 1 do not rotate due to the flow of the fluid (the purge gas, the liquefied gas, or the warming gas) when the valve element 47 closes the pump-side flow passage 41 and when the fluid flows through the submersible pump 1 and the through-hole 57.

A plurality of through-holes 57 may be provided in the valve element 47 as long as the fluid does not rotate the impellers 15. According to this embodiment, the fluid (e.g., the purge gas, the liquefied gas, or the warming gas) can be smoothly introduced into the inside of the submersible pump 1 during the drying-up operation, the cooling-down operation, and the hot-up operation. As a result, the drying-up operation, the cooling-down operation, and the hot-up operation for the submersible pump 1 can be completed in a shorter time. In particular, the through-hole 57 can eliminate a liquid level difference between the inside and outside of the submersible pump 1 when the liquefied gas is introduced into the suction container 2 during the cooling-down operation, and can reduce a stress generated in the submersible pump 1 due to a temperature difference between the inside and outside of the submersible pump 1.

The flow-path switching device 5 described with reference to FIG. 29 may be applied to the flow-path switching devices 5, 5A to 5F in the embodiments described with reference to FIGS. 4 to 27.

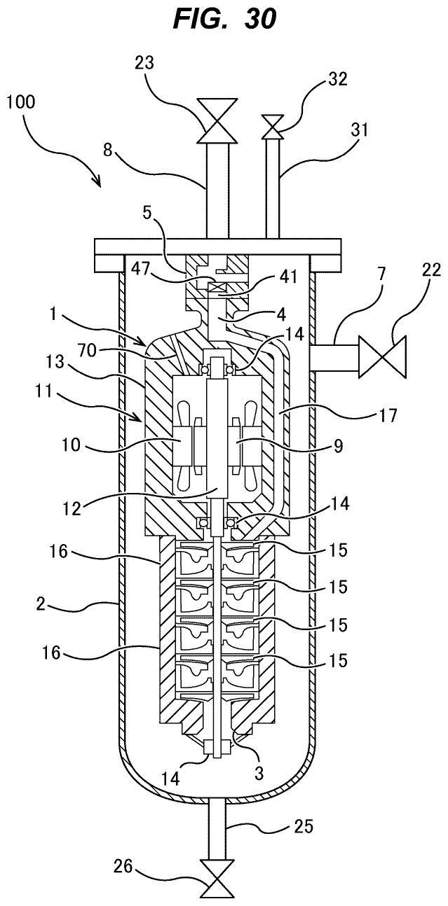

FIG. 30 is a cross-sectional view showing another embodiment of the submersible pump 1. Configuration and operation of this embodiment that will not be specifically described are the same as those of the embodiments described with reference to FIGS. 1 to 3, and therefore repetitive description will be omitted. As shown in FIG. 30, the motor housing 13 of the electric motor 11 has a through-hole 70. The motor rotor 9 and the motor stator 10 are disposed within the motor housing 13. The through-hole 70 is formed in an upper portion of the submersible pump 1 (in this embodiment, in an upper wall of the motor housing 13), and is located above the impellers 15, the motor rotor 9, and the motor stator 10. The through-hole 70 provides a fluid communication between the inside and outside of the submersible pump 1.

A cross-sectional area of the through-hole 70 is smaller than the cross-sectional area of the pump-side flow passage 41 of the flow-path switching device 5. More specifically, the cross-sectional area of the through-hole 70 is such that the impellers 15 of the submersible pump 1 do not rotate due to the flow of the fluid (the purge gas, the liquefied gas, or the warming gas) when the valve element 47 closes the pump-side flow passage 41 and when the fluid flows through the submersible pump 1 and the through-hole 70.

When the fluid (the purge gas, the liquefied gas, or the warming gas) is introduced into the suction container 2 during the drying-up operation, the cooling-down operation, and the hot-up operation, a part of the fluid flows into the submersible pump 1 through the suction inlet 3. A part of the fluid further flows into the motor housing 13 of the electric motor 11. A gas present in the submersible pump 1 is expelled from the submersible pump 1 through the through-hole 70 by the flowing fluid.

According to this embodiment, the fluid (e.g., the purge gas, the liquefied gas, or the warming gas) can be smoothly introduced into the inside of the submersible pump 1 during the drying-up operation, the cooling-down operation, and the hot-up operation. As a result, the drying-up operation, the cooling-down operation, and the hot-up operation for the submersible pump 1 can be completed in a shorter time. In particular, the through-hole 70 can eliminate a liquid level difference between the inside and outside of the submersible pump 1 when the liquefied gas is introduced into the suction container 2 during the cooling-down operation, and can reduce a stress generated in the submersible pump 1 due to a temperature difference between the inside and outside of the submersible pump 1. A plurality of through-holes 70 may be provided in the motor housing 13 as long as the fluid does not rotate the impellers 15.

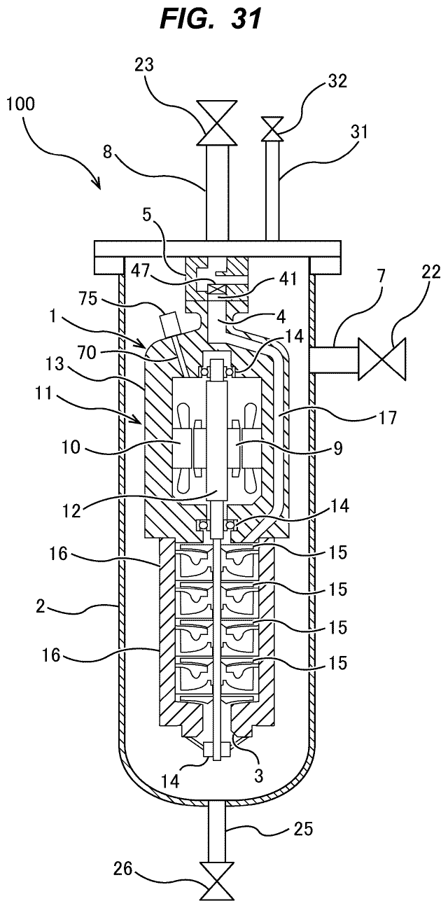

As shown in FIG. 31, the submersible pump 1 may further include a gas vent valve 75 coupled to the through-hole 70. The gas vent valve 75 is fixed to the motor housing 13. The gas vent valve 75 is configured to close when the submersible pump 1 is in operation and to open when the submersible pump 1 is not in operation.

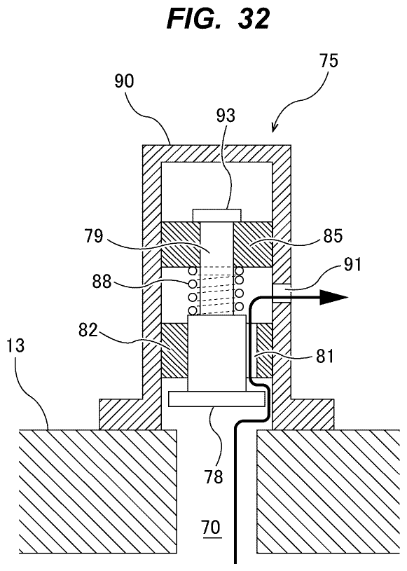

FIG. 32 is a cross-sectional view showing one embodiment of the gas vent valve 75. The gas vent valve 75 includes a seal valve element 78, a valve rod 79 coupled to the seal valve element 78, a valve seat 82 having a flow path 81 that allows the fluid (e.g., the purge gas, the liquefied gas, or the warming gas) to pass therethrough, a rod support structure 85 that supports the valve rod 79 movably in its axial direction, a spring 88 as a biasing member that pushes the seal valve element 78 and the valve rod 79 in a direction away from the valve seat 82, and a valve housing 90 that accommodates the seal valve element 78, the valve rod 79, and the valve seat 82 therein.

The valve housing 90 has a relief hole 91 communicating with the flow passage 81 of the valve seat 82. The relief hole 91 provides a fluid communication between the inside and the outside of the valve housing 90. Furthermore, the inside of the valve housing 90 communicates with the through-hole 70 of the motor housing 13, and the valve housing 90 covers an outlet of the through-hole 70. The spring 88 is disposed between the rod support structure 85 and the seal valve element 78. More specifically, one end of the spring 88 contacts the rod support structure 85, and the other end of the spring 88 contacts the valve rod 79. The spring 88 presses down the valve rod 79 and the seal valve element 78 together, thereby separating the seal valve element 78 from the flow passage 81 of the valve seat 82. Therefore, as shown in FIG. 32, the flow passage 81 communicates with the through-hole 70 of the motor housing 13.

Axial movement of the valve rod 79 and the seal valve element 78 caused by the spring 88 is limited by a rod-movement limiting member 93 fixed to the valve rod 79. Position and structure of the rod-movement limiting member 93 are not limited to the embodiment shown in FIG. 32. In one embodiment, the rod-movement limiting member 93 may be provided on the valve housing 90 or the motor housing 13.

The gas vent valve 75 shown in FIG. 32 is in a state when the submersible pump 1 is not in operation. Specifically, when the submersible pump 1 is not in operation, the gas vent valve 75 is in an open state. The interior of the motor housing 13 communicates with the interior of the suction container 2 (see FIG. 31) through the through-hole 70 and the gas vent valve 75 (i.e., the flow path 81 and the relief hole 91 of the gas vent valve 75).

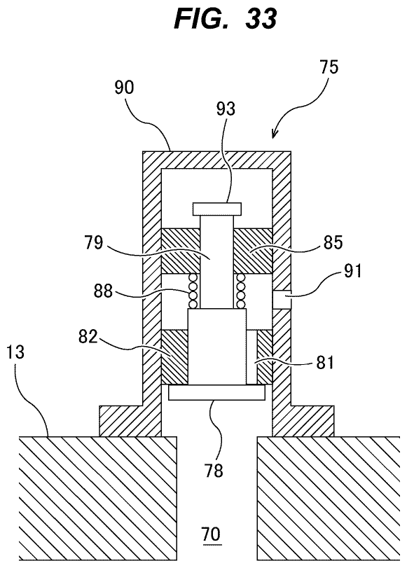

FIG. 33 is a diagram showing a state of the gas vent valve 75 when the submersible pump 1 is in operation. As shown in FIG. 33, when the submersible pump 1 is in operation, a part of the liquefied gas pressurized by the rotation of the impellers 15 flows into the motor housing 13 through the bearing 14. The interior of the motor housing 13 is filled with the pressurized liquefied gas. The liquefied gas flows into the valve housing 90 through the through-hole 70 and pushes up the valve rod 79 and the seal valve element 78 against the force of the spring 88. The seal valve element 78 is pressed against the valve seat 82 by the pressure of the liquefied gas, thus closing the flow path 81 of the valve seat 82. As a result, the fluid communication between the flow path 81 of the valve seat 82 and the through-hole 70 of the motor housing 13 is blocked. In other words, the gas vent valve 75 is closed.

In this way, when the submersible pump 1 is in operation, the gas vent valve 75 is closed by the pressure of the liquefied gas, and the liquefied gas in the motor housing 13 is not discharged to the exterior of the motor housing 13. Therefore, a decrease in the discharge pressure of the submersible pump 1 is prevented.

When the submersible pump 1 is not in operation, the gas vent valve 75 is open, as shown in FIG. 32. Therefore, during the drying-up operation, the cooling-down operation, and the hot-up operation, the fluid (e.g., the purge gas, the liquefied gas, or the warming gas) flows into the motor housing 13 and is discharged from the motor housing 13 through the through-hole 70 and the gas vent valve 75 (i.e., the flow path 81 and the relief hole 91 of the gas vent valve 75). As a result, the fluid can be smoothly introduced into the submersible pump 1.

The embodiment described with reference to FIGS. 30 to 32 may be appropriately applied to the embodiments described with reference to FIGS. 4 to 29.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to a drying-up method, a cooling-down method, and a hot-up method for a submersible pump used for delivering liquefied gas, such as liquid hydrogen, liquid nitrogen, liquefied ammonia, liquefied natural gas, liquefied ethylene gas, or liquefied petroleum gas.

### REFERENCE SIGNS LIST

1,1A,1B,1C,1D,1E,1F submersible pump
2,2A,2B,2C,2D,2E,2F suction container
3 suction inlet
4 discharge outlet
5,5A,5B,5C,5D,5E,5F flow-path switching device
7 suction port
8 discharge port
9 motor rotor
10 motor stator
11 electric motor
12 rotation shaft
13 motor housing
14 bearing
15 impeller
16 pump casing
17 discharge flow path
22 suction valve
23 discharge valve
25 drain line
26 drain valve
31 vent line
32 vent valve
41 pump-side flow passage
42 container-side flow passage
43 outlet flow passage
45 flow-passage structure
47 valve element
50 spring
51 valve seat
55 bypass flow passage
57 through-hole
61 vacuum port
63 vacuum valve
70 through-hole
75 gas vent valve
78 seal valve element
79 valve rod
81 flow path
82 valve seat
85 rod support structure
88 spring
90 valve housing
91 relief hole
93 rod-movement limiting member
100,100A,100B,100C,100D,100E,100F pump apparatus
105 liquefied-gas storage tank
107,108,109,110,131,132,133,134 communication line
111,112 intermediate header
121,122,123,124,125,126 vacuum line

What is claimed is:

1. A drying-up method for removing air from a pump apparatus, comprising:
introducing a purge gas into a suction container of the pump apparatus;
passing the purge gas through a flow-path switching device in the suction container while the purge gas bypasses a submersible pump in the suction container.

2. The drying-up method according to claim 1, wherein the flow-path switching device includes:
a flow-passage structure having a pump-side flow passage, a container-side flow passage, and an outlet flow passage; and
a valve element arranged in the flow-passage structure, the valve element being configured to allow the outlet flow passage to selectively communicate with either the pump-side flow passage or the container-side flow passage, the pump-side flow passage communicating with a discharge outlet of the submersible pump, the container-side flow passage communicating with an interior of the suction container, and the outlet flow passage communicating with a discharge port of the g suction container.

3. The drying-up method according to claim 2, wherein the flow-path switching device further includes a spring that presses the valve element against the flow-passage structure to close the pump-side flow passage.

4. The drying-up method according to claim 2, wherein the flow-path switching device further includes a bypass flow passage that provides a fluid communication between the pump-side flow passage and the outlet flow passage, and a cross-sectional area of the bypass flow passage is smaller than a cross-sectional area of the pump-side flow passage.

5. The drying-up method according to claim 2, wherein the valve element has a through-hole that provides a fluid communication between the pump-side flow passage and the outlet flow passage, and a cross-sectional area of the through-hole is smaller than a cross-sectional area of the pump-side flow passage.

6. The drying-up method according to claim 1, wherein:
while the purge gas is being introduced into the suction container, a part of the purge gas is introduced into the submersible pump to purge a gas in the submersible pump from the submersible pump through a through-hole provided in an upper portion of the submersible pump.

7. The drying-up method according to claim 6, wherein the through-hole is coupled to a gas vent valve which is configured to close when the submersible pump is in operation and open when the submersible pump is not in operation.

8. (canceled)

9. (canceled)

10. The drying-up method according to claim 1, further comprising forming a vacuum in the suction container of the pump apparatus before introducing the purge gas into the suction container of the pump apparatus.

11. A drying-up method for removing air from a suction container that accommodates a submersible pump therein, comprising:
forming a vacuum in the suction container; then
introducing a purge gas into the suction container; and
passing the purge gas through a flow-path switching device in the suction container while the purge gas bypasses the submersible pump.

12. The drying-up method according to claim 11, wherein the flow-path switching device includes:
a flow-passage structure having a pump-side flow passage, a container-side flow passage, and an outlet flow passage; and
a valve element arranged in the flow-passage structure, the valve element being configured to allow the outlet flow passage to selectively communicate with either the pump-side flow passage or the container-side flow passage, the pump-side flow passage communicating with a discharge outlet of the submersible pump, the container-side flow passage communicating with an interior of the suction container, and the outlet flow passage communicating with a discharge port of the suction container.

13. The drying-up method according to claim 12, wherein the flow-path switching device further includes a spring that presses the valve element against the flow-passage structure to close the pump-side flow passage.

14. The drying-up method according to claim 12, wherein the flow-path switching device further includes a bypass flow passage that provides a fluid communication between the pump-side flow passage and the outlet flow passage, and a cross-sectional area of the bypass flow passage is smaller than a cross-sectional area of the pump-side flow passage.

15. The drying-up method according to claim 12, wherein the valve element has a through-hole that provides a fluid communication between the pump-side flow passage and the outlet flow passage, and a cross-sectional area of the through-hole is smaller than a cross-sectional area of the pump-side flow passage.

16. The drying-up method according to claim 11, wherein while the purge gas is being introduced into the suction container, a part of the purge gas is introduced into the submersible pump to purge a gas in the submersible pump from the submersible pump through a through-hole provided in an upper portion of the submersible pump.

17. The drying-up method according to claim 16, wherein the through-hole is coupled to a gas vent valve which is configured to close when the submersible pump is in operation and open when the submersible pump is not in operation.

18. A cooling-down method for supplying liquefied gas to a pump apparatus, comprising:
introducing a liquefied gas into a suction container of the pump apparatus;
passing the liquefied gas through a flow-path switching device in the suction container while the liquefied gas bypasses a submersible pump in the suction container.

19. The cooling-down method according to claim 18, wherein the flow-path switching device includes:
a flow-passage structure having a pump-side flow passage, a container-side flow passage, and an outlet flow passage; and
a valve element arranged in the flow-passage structure, the valve element being configured to allow the outlet flow passage to selectively communicate with either the pump-side flow passage or the container-side flow passage, the pump-side flow passage communicating with a discharge outlet of the submersible pump, the container-side flow passage communicating with an interior of the suction container, and the outlet flow passage communicating with a discharge port of the suction container.

20. The cooling-down method according to claim 19, wherein the flow-path switching device further includes a spring that presses the valve element against the flow-passage structure to close the pump-side flow passage.

21. The cooling-down method according to claim 19, wherein the flow-path switching device further includes a bypass flow passage that provides a fluid communication between the pump-side flow passage and the outlet flow passage, and a cross-sectional area of the bypass flow passage is smaller than a cross-sectional area of the pump-side flow passage.

22. The cooling-down method according to claim 19, wherein the valve element has a through-hole that provides a fluid communication between the pump-side flow passage and the outlet flow passage, and a cross-sectional area of the through-hole is smaller than a cross-sectional area of the pump-side flow passage.

23. The cooling-down method according to claim 18, wherein:
while the liquefied gas is being introduced into the suction container, a part of the liquefied gas is introduced into the submersible pump to purge a gas in the submersible pump from the submersible pump through a through-hole provided in an upper portion of the submersible pump.

24. The cooling-down method according to claim 23, wherein the through-hole is coupled to a gas vent valve which is configured to close when the submersible pump is in operation and open when the submersible pump is not in operation.

25. (canceled)

26. (canceled)

27. The cooling-down method according to claim 18, wherein the liquefied gas is introduced into the suction container through a drain line coupled to a bottom of the suction container.

28. A cooling-down method for cooling a submersible pump disposed in a suction container, comprising:
introducing liquefied gas into the suction container; and
passing the liquefied gas through a flow-path switching device in the suction container while the liquefied gas bypasses the submersible pump.

29. The cooling-down method according to claim 28, wherein the liquefied gas is introduced into the suction container through a drain line coupled to a bottom of the suction container.

30. The cooling-down method according to claim 28, wherein the flow-path switching device includes:
a flow-passage structure having a pump-side flow passage, a container-side flow passage, and an outlet flow passage; and
a valve element arranged in the flow-passage structure, the valve element being configured to allow the outlet flow passage to selectively communicate with either the pump-side flow passage or the container-side flow passage, the pump-side flow passage communicating with a discharge outlet of the submersible pump, the container-side flow passage communicating with an interior of the suction container, and the outlet flow passage communicating with a discharge port of the suction container.

31. The cooling-down method according to claim 30, wherein the flow-path switching device further includes a spring that presses the valve element against the flow-passage structure to close the pump-side flow passage.

32. The cooling-down method according to claim 30, wherein the flow-path switching device further includes a bypass flow passage that provides a fluid communication between the pump-side flow passage and the outlet flow passage, and a cross-sectional area of the bypass flow passage is smaller than a cross-sectional area of the pump-side flow passage.

33. The cooling-down method according to claim 30, wherein the valve element has a through-hole that provides a fluid communication between the pump-side flow passage and the outlet flow passage, and a cross-sectional area of the through-hole is smaller than a cross-sectional area of the pump-side flow passage.

34. The cooling-down method according to claim 28, wherein while the liquefied gas is being introduced into the suction container, a part of the liquefied gas is introduced into the submersible pump to purge a gas in the submersible pump from the submersible pump through a through-hole provided in an upper portion of the submersible pump.

35. The cooling-down method according to claim 34, wherein the through-hole is coupled to a gas vent valve which is configured to close when the submersible pump is in operation and open when the submersible pump is not in operation.

36. A hot-up method for supplying warming gas to a pump apparatus, comprising:
introducing a warming gas into a first suction container of the first pump apparatus;
passing the warming gas through a flow-path switching device in the suction container while the warming gas bypasses a submersible pump in the suction container.

37. The hot-up method according to claim 36, wherein the flow-path switching device includes:
a flow-passage structure having a pump-side flow passage, a container-side flow passage, and an outlet flow passage; and
a valve element arranged in the flow-passage structure, the valve element being configured to allow the outlet flow passage to selectively communicate with either the pump-side flow passage or the container-side flow passage, the pump-side flow passage communicating with a discharge outlet of the submersible pump, the container-side flow passage communicating with an interior of the suction container, and the outlet flow passage communicating with a discharge port of the suction container.

38. The hot-up method according to claim 37, wherein the flow-path switching device further includes a spring that presses the valve element against the flow-passage structure to close the pump-side flow passage.

39. The hot-up method according to claim 37, wherein the flow-path switching device further includes a bypass flow passage that provides a fluid communication between the pump-side flow passage and the outlet flow passage, and a cross-sectional area of the bypass flow passage is smaller than a cross-sectional area of the pump-side flow passage.

40. The hot-up method according to claim 37, wherein the valve element has a through-hole that provides a fluid communication between the pump-side flow passage and the outlet flow passage, and a cross-sectional area of the through-hole is smaller than a cross-sectional area of the pump-side flow passage.

41. The hot-up method according to claim 36, wherein:
while the warming gas is being introduced into the suction container, a part of the warming gas is introduced into the submersible pump to purge a gas in the submersible pump from the submersible pump through a through-hole provided in an upper portion of the submersible pump.

42. The hot-up method according to claim 41, wherein the through-hole is coupled to a gas vent valve which is configured to close when the submersible pump is in operation and open when the submersible pump is not in operation.

43. (canceled)

44. (canceled)

45. The hot-up method according to claim 36, wherein the warming gas is introduced into the suction container through a drain line coupled to a bottom of the suction container.

46. A hot-up method for warming a submersible pump disposed in a suction container, comprising:
introducing a warming gas into the suction container; and
passing the warming gas through a flow-path switching device in the suction container while the warming gas bypasses the submersible pump.

47. The hot-up method according to claim 46, wherein the warming gas is introduced into the suction container through a drain line coupled to a bottom of the suction container.

48. The hot-up method according to claim 46, wherein the flow-path switching device includes:
a flow-passage structure having a pump-side flow passage, a container-side flow passage, and an outlet flow passage; and
a valve element arranged in the flow-passage structure, the valve element being configured to allow the outlet flow passage to selectively communicate with either the pump-side flow passage or the container-side flow passage, the pump-side flow passage communicating with a discharge outlet of the submersible pump, the container-side flow passage communicating with an interior of the suction container, and the outlet flow passage communicating with a discharge port of the suction container.

49. The hot-up method according to claim 48, wherein the flow-path switching device further includes a spring that presses the valve element against the flow-passage structure to close the pump-side flow passage.

50. The hot-up method according to claim 48, wherein the flow-path switching device further includes a bypass flow passage that provides a fluid communication between the pump-side flow passage and the outlet flow passage, and a cross-sectional area of the bypass flow passage is smaller than a cross-sectional area of the pump-side flow passage.

51. The hot-up method according to claim 48, wherein the valve element has a through-hole that provides a fluid communication between the pump-side flow passage and the outlet flow passage, and a cross-sectional area of the through-hole is smaller than a cross-sectional area of the pump-side flow passage.

52. The hot-up method according to claim 46, while the warming gas is being introduced into the suction container, a part of the warming gas is introduced into the submersible pump to purge a gas in the submersible pump from the submersible pump through a through-hole provided in an upper portion of the submersible pump.

53. The hot-up method according to claim 52, wherein the through-hole is coupled to a gas vent valve which is configured to close when the submersible pump is in operation and open when the submersible pump is not in operation.
